(19) United States
(12) Patent Application Publication
(10) Pub. No.: US 2005/0038688 A1
(43) Pub. Date: Feb. 17, 2005

(54) System and method for matching local buyers and sellers for the provision of community based services

(76) Inventors: Albert E. Collins, Stamford, CT (US); William P. Kane JR., New York, NY (US); Ajaz Rana, Monmouth Junction, NJ (US); Leo E. Scullin, New York, NY (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/641,483

(22) Filed: Aug. 15, 2003

(51) Int. Cl. G06F 17/60

(52) U.S. Cl. 705/9; 705/37

(57) ABSTRACT

A consumer-centric service for matching local consumers with local service providers. A matching is performed between consumer needs and local vendor capabilities and the results are presented back to the consumer so that the choice of which vendors to be contacted is left to the consumer. Mechanisms are provided for immediately and automatically contacting the chosen vendor in one or more of a plurality of communication media and offering the chosen vendor the details of the consumer's request, including the preferred method of contact information, for a fee. Also, the system immediately informs the consumer about the status of the vendor contacts, including whether or not the vendor has accepted the lead. Once a chosen vendor accepts the lead, the consumer is contacted by the vendor, in the manner requested by the consumer. Thus, the invention enables consumers to maintain control over the selection and contact process with matched vendors. The system of the invention is particularly advantageous for providing community based services such as babysitting, cleaning, painting, software support, typing, and in obtaining professional services from professionals such as electricians, carpenters, gardeners, accountants, lawyers, and the like.

### FIELD OF THE INVENTION

The invention described herein relates to an Internet based system and method for matching the needs of the residents of a community with the capabilities of those in the community who wish to sell their services. The invention uses a filtering mechanism to match the sellers' services with the buyer's needs and empowers the buyer to select the desired service provider.

### BACKGROUND OF THE INVENTION

Matching consumers who need a service performed, such as tutoring, physical therapy, or plumbing, with local service providers in their community has been the role for many local media channels. Local newspaper classified ads, local directories such as the “Yellow Pages,” community publications such as “penny savers” and, recently, Internet based global and local online offerings have sought to fill this matching need. To date, the most prominent of the online offerings, distributed under many other brand names, is RespondNet.

The RespondNet system is used by many companies, most notably, Verizon SuperPages, Inc., as the engine for its “MerchantMatch” service. Other online services similar to RespondNet include: ImproveNet, ServiceMagic, ServiceMaster, Elance.com, and iMandi. RespondNet and these other online systems that seek to match consumers with local service providers are vendor-centric. Vendor-centric means the preponderance of commerce enabling information and usefulness is directed to the suppliers of services, rather than the consumers of services. Specifically, in the vendor-centric online systems such as RespondNet, the result of the matching between consumer needs and vendor capabilities is not revealed to the consumers. Additionally, the choice of which of these vendors to contact is not made by consumers but by the RespondNet system or administrators. The matching process in these systems is opaque, or a “black box” to the consumers.

Another reason that RespondNet and the systems like RespondNet are not consumer-centric is that they do not provide any information on what other consumers think about a particular vendor. Verizon's MerchantMatch, which uses RespondNet, does ask the consumers to rate the quality of services received from the vendors; however, their ratings are not made accessible to everyone. In a consumer-centric system, it would be desirable to provide such vendor ratings to consumers to enable them to make informed choices.

Other systems known in the art for facilitating a consumer's search for a service provider are categorized herein as “Little/No Matching” systems that may be “Category Based” or “Keyword Search” systems. Prominent examples of “Category Based” systems include Verizon's SuperPages and the Internet based Yellow Pages. Google, Overture, and CraigsList are examples of the “Keyword Search” systems. These “Little/No Matching” systems allow consumers to search, view vendor details, and select the vendors they would like to work with. However, the “Little/No Matching” systems such as SuperPages and the Internet based Yellow Pages enable the user's search to be narrowed only to the extent of the relevant category of service providers. As a result, the user is often faced with having to sift through long lists of service providers some of whom, for example, may not be available or may not have the capability to do exactly what a consumer is in need of. The situation is far worse in the case of general purpose search engines (e.g., Google and Overture) where users can only specify a set of keywords. With the exception of SuperPages, the “Little/No Matching” systems provide no support for contacting the vendors. They also do not provide any support for tracking the status of the consumer requests. Moreover, the “Little/No Matching” systems do not provide vendor ratings to aid the consumers in their decision-making.

Other systems are known for facilitating vendor/consumer matches for service transactions.

For example, Cook describes in U.S. Patent Application Publication No. US 2002/0059095A1 a lead management system that processes lead data to develop a lead profile so that the attractiveness of the lead can be determined. The lead profiles may be modified in response to changes in the customer information and interested parties may be informed of changes in the lead profile.

Tenorio describes in U.S. Patent Application Publication No. US 2002/0174022A1 a system for pre-qualifying sellers during the matching phase of an electronic commerce transaction. The disclosed system manages a hierarchical directory structure of product classes and their attributes and is primarily a product-oriented system that associates product data with the vendors. Buyers may search for products in the directory structure and find the vendors that match their needs.

Craig, et al. describe in U.S. Patent Application Publication No. US 2003/0069744A1 a networked referral commission system that provides a collective listing organization that maintains a collection of listings from listing sales brokers. Buyers search against the consolidated listing database and, when a buyer selects a listing, the broker is provided with the contact information of the buyer. Once the transaction is complete (i.e., the buyer buys the property), the lead fee is spilt between the owners of the consolidated listing database and the broker. Wright, et al. describe in U.S. Patent Application Publication No. US 2003/0083895A1 a networked referral commission system similar to the Craig, et al system except that a buyer can specify a date/time of his/her preference to view a property and the system delivers the buyer's preferred viewing time to the broker.

Luke, et al. describe in U.S. Pat. No. 6,131,087 a method for automatically identifying, matching, and near-matching buyers and sellers in electronic market transactions that implements an algorithm for representing various dimensions of the solicitation and the offer data in the form of numerical ranges and matches the solicitations with the offers in terms of their similarity on various dimensions.

Vega describes in U.S. Patent Application Publication No. US 2002/0069079A1 a method and system for facilitating service transactions by matching buyers and sellers of services. The system includes a mechanism for defining a set of service classifications and material items so that services may be more freely tradeable. The system registers buyers and sellers and maintains a variety of data on participants including credit, transactions, social intelligence, marketing, and the like. Vega proposes to use numerous sophisticated data mining, artificial intelligence, neural networks, and related techniques to match the requests-for-offers with offers. The system matches sets of offers from different vendors against requests for offers as a package and provides for both online and offline negotiation and execution of transactions as well as the ability to automatically effectuate transactions through a legally binding mechanism defined for buyers and sellers. The system purportedly functions both as a centralized and a distributed system. While the system disclosed by Vega would be useful in standardizing requests for service, Vega does not disclose a system that empowers a consumer to select vendors in the geographic area that have the expertise needed by the consumer and to facilitate the passing of the consumer's lead to the vendor in a manner designated by the vendor. Vega also does not allow the consumer to specify which ones or how many of the matched providers should be informed of their needs and to specify when, where, and how the providers should get in touch with them.

Generally speaking, these systems fail to combine consumer control with status tracking, vendor ratings, and other consumer-centric features described in more detail herein. The present invention is designed to provide such advantageous features.

### SUMMARY OF THE INVENTION

The invention is a consumer-centric service for matching local consumers with local service providers on an Internet enabled system accessible via one or more of a plurality of communication media. The service is consumer-centric because a matching is performed between consumer needs and local vendor capabilities and the results are presented back to the consumer so that the choice of which vendors to be contacted is left to the consumer. The invention provides an additional convenience benefit to consumers, because mechanisms for immediately and automatically contacting the vendor are provided. The system will automatically contact the chosen vendor and offer them the details of the consumer's request, including the preferred method of contact information, for a fee. Also, the system immediately informs the consumer about the status of the vendor contacts, including whether or not the vendor has accepted the lead. Thus, the invention enables consumers to maintain control over the selection and contact process with matched vendors. Consumer confidence about the quality of the match results and prospective vendor behavior is heightened thereby so as to encourage trust and more frequent system use.

The system of the invention matches the needs of the residents of a community (i.e., “consumers”, “buyers”) with the capabilities of those who want to sell their services (i.e., “vendors”, “providers”) using a filtering process as distinguished from a searching mechanism for matching the sellers' services with buyers' needs. The system includes software that captures the capabilities of the sellers of local services in a community and makes them publicly accessible. It allows consumers in need to describe their requirements and find the sellers whose capabilities match their needs. Upon receiving the query results, the consumer can instruct the system to instantaneously inform the providers about his/her service needs. The system also allows the consumer to specify which ones or how many of the matched providers should be informed of his/her needs. Consumers can also specify when, where, and how the providers should get in touch with them.

The system of the invention automatically contacts the service providers via the means/modes preferred by the providers and shares the business opportunity with them. Without revealing the identity and the contact information of the consumer, the system informs the providers about the service needs and requirements of the consumer. At this point, the system asks the providers if they would be interested in pursuing the lead. The provider is made aware of the fact that if they accept the lead they would be charged a small fee and in return they will gain access to the identity and the contact information of the potential consumer. If the provider chooses to accept the lead, the system automatically charges the fee to the provider. With consumer information in hand, it is up to the vendor to settle the terms of the service delivery with the consumer. The system does not interfere in the transaction between the consumer and the vendor.

The system of the invention also allows the consumers to rate the quality of services rendered by the providers. The providers also can post ratings of their experience with the buyer. The system compiles the ratings into meaningful indicators to aid the decision making process of both consumers and the providers. The system of the invention also may automatically collect data on vendor response time and the vendor's lead acceptance rate, where the vendor response time is defined as the average time it takes a vendor to respond to (i.e., accept or reject) a lead and the acceptance rate is defined as the ratio of the number of leads accepted by a vendor to the total number of leads received by that vendor.

### BRIEF DESCRIPTION OF THE DRAWINGS

The features and advantages of the invention will be apparent from the following detailed description in conjunction with the drawings, of which:

FIG. 1 illustrates the types of users of the system of the invention: consumers, service providers, and administrative personnel.

FIG. 2 illustrates the user interface options through which the users may interact with the system of the invention.

FIG. 3 illustrates an embodiment of the system of the invention, including its major software and hardware components.

FIG. 3a illustrates the service configuration software used by vendors to create service profiles.

FIG. 3b illustrates the software used by the consumer to find a service provider in accordance with the invention.

FIG. 4 illustrates the use cases of the system software loaded on the system server of the invention.

FIG. 5 illustrates that the system server can select a document variant matching the client capabilities or can apply a transformation to generate a suitable variant.

FIG. 6a illustrates the configure service use case for a web interface.

FIG. 6b illustrates the Configure Service Page used by the vendor to configure his/her service on the system of the invention.

FIG. 6c illustrates the Contact Preferences Page used by the vendor to specify the desired mode of contact.

FIG. 7 illustrates the configure service use case for a customer service representative interface.

FIG. 8a illustrates the find service provider use case for a web interface.

FIG. 8b illustrates the Configure Request Page used by the consumer to find a service provider using the system of the invention.

FIG. 8c illustrates the Confirm Query Page used by the consumer to confirm the service request information.

FIG. 8d illustrates the results (i.e., matched service providers) displayed to the consumer after a search of the available vendors in the web registry.

FIG. 9 illustrates the find service provider use case for a POTS interface.

FIG. 10 illustrates the find service provider use case for a WAP interface.

FIG. 11 illustrates the find service provider use case for a DTV interface.

FIG. 12 illustrates the select vendor and accept/reject use case for a web interface.

FIG. 13 illustrates the select vendor and accept/reject use case for a voice interface.

FIG. 14 illustrates the select vendor and accept/reject use case for a WAP interface.

FIG. 15 illustrates the select vendor and accept/reject use case for a DTV interface.

FIG. 16 illustrates the check status use case for a web interface.

FIG. 17 illustrates the check status use case for a POTS interface.

FIG. 18 illustrates the check status use case for a WAP interface.

FIG. 19 illustrates the check status use case for a DTV interface.

FIG. 20 illustrates the Check Status Page presented to the consumer when checking the status of a service request.

FIG. 21 illustrates the provider rating use case for a web interface.

FIG. 22 illustrates the provider rating use case for a POTS interface.

FIG. 23 illustrates the provider rating use case for a WAP interface.

FIG. 24 illustrates the provider rating use case for a DTV interface.

### DETAILED DESCRIPTION OF ILLUSTRATIVE EMBODIMENTS

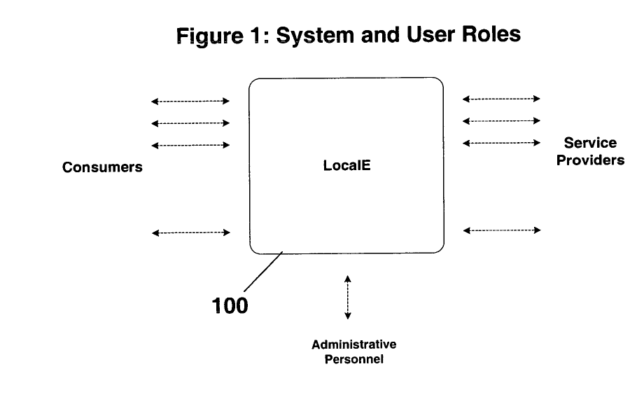

A detailed description of an exemplary embodiment of the present invention will now be described with reference to FIGS. 1-24. Although this description provides detailed examples of possible implementations of the present invention, it should be noted that these details are intended to be exemplary and in no way delimit the scope of the invention.

Definitions:

DTV (Digital TV): A digital television standard for the U.S. approved by the FCC in 1996 and developed by the Advanced Television Systems Committee (ATSC). In November 1998, DTV debuted in major U.S. cities. In order to receive DTV, one needs a digital TV set or a set-top box for an existing analog TV.

ebXML (Electronic Business XML): An XML-based set of definitions for electronic transactions and business collaboration. Based on work done by the United Nations Centre for Trade Facilitation and Electronic Business (UN/CEFACT), ebXML provides descriptors for modeling business processes that includes the definition of software components. ebXML is designed for global interoperability and to facilitate the transition from older electronic data interchange (EDI) formats to the Internet. The ebXML specifications are jointly sponsored by OASIS and UN/CEFACT. More information may be found at www.ebxml.org.

Gateway: A computer that performs protocol conversion between different types of networks or applications. For example, a gateway can convert a TCP/IP packet to a NetWare IPX packet and vice versa or from AppleTalk to DECnet, from SNA to AppleTalk and so on. Gateways function at Layer 4 and above in the OSI model. They perform complete conversions from one protocol to another rather than simply support one protocol from within another, such as IP tunneling. Sometimes routers can implement gateway functions.

Headend: The headend is the control center of a cable television system, where incoming signals are amplified, converted, processed and combined into a common cable along with any original cablecasting, for transmission to subscribers. The system usually includes antennas, preamplifiers, frequency converters, demodulators, modulators, processors and other related equipment.

HTML (HyperText Markup Language): The document format used on the World Wide Web. Web pages are built with HTML tags (codes) embedded in the text. HTML defines the page layout, fonts and graphic elements as well as the hypertext links to other documents on the Web. Each link contains the URL, or address, of a Web page residing on the same server or any server worldwide, hence “World Wide” Web.

HTTP (HyperText Transport Protocol): The communications protocol used to connect to servers on the World Wide Web. Its primary function is to establish a connection with a Web server and transmit HTML pages to the client browser. Addresses of Web sites begin with an http:// prefix; however, Web browsers typically default to the HTTP protocol.

IP (Internet Protocol): The network layer protocol in the TCP/IP communications protocol suite (the “IP” in TCP/IP). IP contains a network address and allows messages to be routed to a different network or subnet. IP does not ensure delivery of a complete message, and the TCP transport layer is used to provide that guarantee.

IVR (Interactive Voice Response): An automated telephone information system that speaks to the caller with a combination of fixed voice menus and real-time data from databases. The caller responds by pressing digits on the telephone or speaking words or short phrases. Applications include bank-by-phone, flight-scheduling information, and automated order entry and tracking. Most IVR systems reside in Wintel PCs equipped with special ISA or PCI board-level products that contain DSP chips. These specialized processors connect to the telephone system, which actually switches the calls. IVR systems are also networked on LANs and WANs.

MSO (Multiple System Operator): The name for a cable provider offering cable service to its customers. A company that operates multiple cable systems.

PDA (Personal Digital Assistant): A handheld computer that serves as an organizer for personal information. It generally includes at least a name and address database, to-do list and note taker. PDAs are often pen based and use a stylus to tap selections on menus and to enter printed characters. The unit may also include a small on-screen keyboard which is tapped with the pen. Data are synchronized between the PDA and desktop computer via cable or wireless transmission.

POTS Plain Old Telephone System or Service): See PSTN.

PSTN (Public Switched Telephone Network) The worldwide voice telephone network. Once only an analog system, the heart of most telephone networks today is all digital. In the U.S., most of the remaining analog lines are the ones from one's house or office to the telephone company's central office (CO).

SOAP (Simple Object Access Protocol) A message-based protocol based on XML for accessing services on the Web. Initiated by Microsoft, IBM and others, it employs XML syntax to send text commands across the Internet using HTTP. Similar in purpose to the DCOM and CORBA distributed object systems, but lighter weight and less programming intensive (at least initially), SOAP is expected to become widely used to invoke services throughout the Web. Because of its simple exchange mechanism, SOAP can also be used to implement a messaging system. SOAP is supported in COM, DCOM, Internet Explorer and Microsoft's Java implementation.

STB (Set-top Box): The cable TV box that “sits on top” of the TV set. A variety of new set-top boxes are emerging for Internet TV and other interactive services.

TCP/IP (Transmission Control Protocol/Internet Protocol): A communications protocol developed under contract from the U.S. Department of Defense to internetwork dissimilar systems. Invented by Vinton Cerf and Bob Kahn, this de facto UNIX standard is the protocol of the Internet and has become the global standard for communications. TCP provides transport functions, which ensures that the total amount of bytes sent is received correctly at the other end. UDP, which is part of the TCP/IP suite, is an alternate transport that does not guarantee delivery. It is widely used for real-time voice and video transmissions where erroneous packets are not retransmitted. TCP/IP is a routable protocol, and the IP part of TCP/IP provides this capability. In a routable protocol, all messages contain not only the address of the destination station, but the address of a destination network. This allows TCP/IP messages to be sent to multiple networks (subnets) within an organization or around the world, hence its use in the worldwide Internet.

TTS (Text-To-Speech): Converting text into voice output using speech synthesis techniques. Although initially used by the blind to listen to written material, it is now used extensively to convey financial data, e-mail messages and other information via telephone for everyone. Early text-to-speech (TTS) systems had a very robotic sound; however, with the advent of high-speed chips and advanced software techniques, text-to-speech has become more natural.

UDDI (Universal Description, Discovery and Integration): An industry initiative for a universal business registry (catalog) of Web Services. Led by Ariba, IBM, Microsoft and others, UDDI is designed to enable software to automatically discover and integrate with services on the Web. Using a UDDI browser, humans can also review the information contained in the registry, which is a network of servers on the Internet similar to the Domain Name System (DNS). UDDI contains white pages (addresses and contacts), yellow pages (industry classification) and green pages (description of services). The green pages include the XML version, type of encryption and a Document Type Definition (DTD) of the standard. UDDI messages ride on top of the SOAP protocol, which invokes services on the Web. More information may be found at www.uddi.org.

URI (Uniform Resource Identifier): The addressing technology that identifies every file (Web page, image, video clip, script, etc.) stored on the Internet. Technically, URLs are subsets of URIs, but in practice, the terms URI and URL are used interchangeably. Sometimes, URI refers only to the identifier part of the URL. For example, in the domain name

www.computerlanguage.com/java.htm

the /java.htm would be the identifier.

URL (Uniform Resource Locator): The address that defines the route to a file on the web or any other Internet facility. URLs are typed into the browser to access web pages, and URLs are embedded within the pages themselves to provide the hypertext links to other pages. The URL contains the protocol prefix, port number, domain name, subdirectory names and file name. Port addresses are generally defaults and are rarely specified. To access a home page on a web site, only the protocol and domain name are required.

Voice Gateway: A gateway that bridges the PSTN and IP networks by converting and compressing voice into IP packets.

VoiceXML: An extension to XML that defines voice segments and enables access to the Internet via telephones and other voice-activated devices. AT&T, Lucent and Motorola created the Voice XML Forum to support this development. More information may be found at www.voicexml.org.

WAP (Wireless Application Protocol): A standard for providing cellular phones, pagers and other handheld devices with secure access to e-mail and text-based Web pages. Introduced in 1997 by Phone.com (now Openwave Systems), Ericsson, Motorola and Nokia, WAP provides a complete environment for wireless applications that includes a wireless counterpart of TCP/IP and a framework for telephony integration such as call control and phone book access. WAP features the Wireless Markup Language (WML), which was derived from Phone.com's HDML and is a streamlined version of HTML for small screen displays. It also uses WMLScript, a compact JavaScript-like language that runs in limited memory. WAP also supports handheld input methods such as a keypad and voice recognition. Independent of the air interface, WAP runs over all the major wireless networks in place now and in the future. It is also device independent, requiring only a minimum functionality in the unit so that it can be used with a myriad of phones and handheld devices.

WAP Gateway (Wireless Application Protocol gateway): Software that decodes and encodes requests and responses between the smart phone microbrowsers and the Internet. It decodes the encoded WAP requests from the microbrowser and sends the HTTP requests to the Internet or to a local application server. It encodes WML and HDML data returning from the Web for transmission to the microbrowser in the handset.

Web (World Wide Web): An Internet service that links documents locally and remotely. Documents are stored on the Internet in “web servers” that store and disseminate “web pages.” The web pages are accessed by the user with software called a “web browser,” the two most popular being Internet Explorer and Netscape Navigator. The web page, or web document, contains text, graphics, animations and videos as well as hypertext links. The links in the page let users jump from page to page (hypertext) whether the pages are stored on the same server or on servers around the world.

Web Services: Web-based applications that dynamically interact with other web applications using open standards that include XML, UDDI and SOAP. Such applications typically run behind the scenes, one program “talking to” another (server to server). Microsoft's .NET and Sun's Sun ONE (J2EE) are the major development platforms that natively support these standards. Web Services enable software components to interact with each other around the world. In the past, this has only occasionally been realized within private networks using the industry standard CORBA and Microsoft's DCOM distributed component platforms. However, Web Services use XML-based protocols that are lightweight and simpler in comparison. Although the term became the hot buzzword at the turn of the century, Web Services still require cooperation and agreement among people to define business transactions and processes. Web Services standards only define the format and transport architectures, but the meaning of each element of data exchanged also has to be defined ahead of time by industry consensus.

WSDL (Web Services Description Language): A protocol for a Web Service to describe its capabilities. Co-developed by Microsoft and IBM, WSDL describes the protocols and formats used by the service. WSDL descriptions can be housed in a UDDI directory, and the combination is expected to promote the use of Web Services worldwide.

XHTML (EXtensible HTML): The combining of HTML 4.0 and XML 1.0 into a single format for the Web. XHTML enables HTML to be eXtended (the X in XHTML) with proprietary tags. XHTML is also coded more rigorously than HTML and must conform to the rules of structure more than HTML.

XHTML+Voice: The combining of XHTML and VoiceXML to provide web sites with voice capabilities. This multimodal capability enables handheld devices that browse the web to interact with voice instead of the screen. Also known as “X+V,” XHTML+Voice enables VoiceXML event handlers to be implemented via the event handling capability of the Document Object Model (DOM).

XML (EXtensible Markup Language): An open standard for describing data from the W3C. It is used for defining data elements on a Web page and business-to-business documents. It uses a similar tag structure as HTML; however, whereas HTML defines how elements are displayed, XML defines what those elements contain. HTML uses predefined tags, but XML allows tags to be defined by the developer of the page.

XPath (XML PATH Language): A component of the Extensible Stylesheet Language (XSL) that is used to identify tagged XML elements. It is also used to calculate numbers and manipulate strings. XPath syntax is somewhat like the directory addressing in UNIX, which uses a slash for the root directory as well as the separator between hierarchies.

XQuery (XML QUERY Language): A language for querying XML documents from the W3C. Compatible with related W3C standards (XML Schema, XSLT, etc.), XQuery was derived from the XPath language and uses the same syntax for path expressions. Based on the XQuery data model, XQuery processes the query by parsing the XML document, the schema and the query into hierarchical node trees. It also generates an output schema with the query results. XQuery is expected to become as popular for querying XML documents as SQL is for relational databases.

XSL (extensible Stylesheet Language): A standard from the W3C for describing a style sheet for XML documents. It is the XML counterpart to the Cascading Style Sheets (CSS) in HTML and is also compatible with CSS2. XSL is made up of three components: (1) XSL Transformations (XSLT) is the processing language for XSL. It is used to convert XML documents into HTML or other document types and may be used independently of XSL. (2) XML Path Language (Xpath) is used to identify and select tagged elements within an XML document, and (3) XSL Formatting Objects (XSL FO) provides the format vocabulary.

Method of Using the System of the Invention:

A consumer seeking a local service provider will connect to the system 100 of the invention (FIG. 1) using an Internet web browser, telephone IVR or DTV interface and, in the case of an Internet connection, the system 100 will display the home page. The consumer then chooses the category of service he/she is seeking, and the system 100 displays the “configure request page.” The consumer answers/fills-in a series of questions about his/her need, including when and where the service should be delivered, details of the job to be performed, the qualifications of the vendor, and other pertinent information depending on the category of service. When complete, the consumer submits the request.

At this point in the interaction, the system 100 of the invention differs from other online systems that offer matching services. Other systems take in the consumer's request and determine which providers will receive it, where the consumer has already exited the system. Instead, the system 100 of the invention presents to the consumer a list of local vendors who have indicated that they are available and able to meet the specifics of the consumer's request. The system 100 of the invention will then display to the consumer a list of all vendors that are able and available to meet the consumer's request. Information presented at this point includes the vendor's name (or company name) and location, and a rating from other system users. Consumers can choose to view further information on any vendor, including information such as years of experience in the service category, fees or rates, and insurance coverage. Some information is provided at the vendor's option, and some is mandatory, depending on the service category.

When the consumer has made a decision about which vendor or vendors to contact, he/she will indicate this by selecting them from the list and submitting this selection. As noted above, the ability to make this selection is not available in other systems, let alone the ability to see the specifically matched vendors. The system 100 of the invention then confirms the selection and asks the consumer to indicate how he/she prefers to be contacted by any vendors who accept the consumer's request.

The system 100 then contacts the vendors, in the order and according to an interval time optionally specified by the consumer. The method of vendor contact by the system 100 (telephone call to their mobile phone, email, fax or via a web page) is selected by the vendor when the vendor configures the service within the system 100. Information conveyed to the vendor during this contact includes details of the consumer request such as when and where the service must be performed and any other consumer requirements except for the prospective consumer's contact information. The vendor is given an option to accept or reject each lead, and may be charged a fee if they accept. If the vendor accepts the lead, it is given the consumer's contact information. The consumer can specify whether the vendor contacts stop once any vendor accepts the lead, or if the system 100 should contact all the matched vendors regardless of whether any have accepted. The status of the contacts will also be relayed to the vendor, including information such as the number of vendors contacted, the order of contact, and the number who have accepted the lead and have been provided the consumer contact details by the system 100.

While the vendor contacts are occurring, the consumer is directed to a status page, from which he/she may view the results of the vendor contacts. As each vendor is contacted, the results (such as whether or not the vendor accepted the lead) are displayed in the status page. The consumer can return to this page at any time to view the status.

User Roles

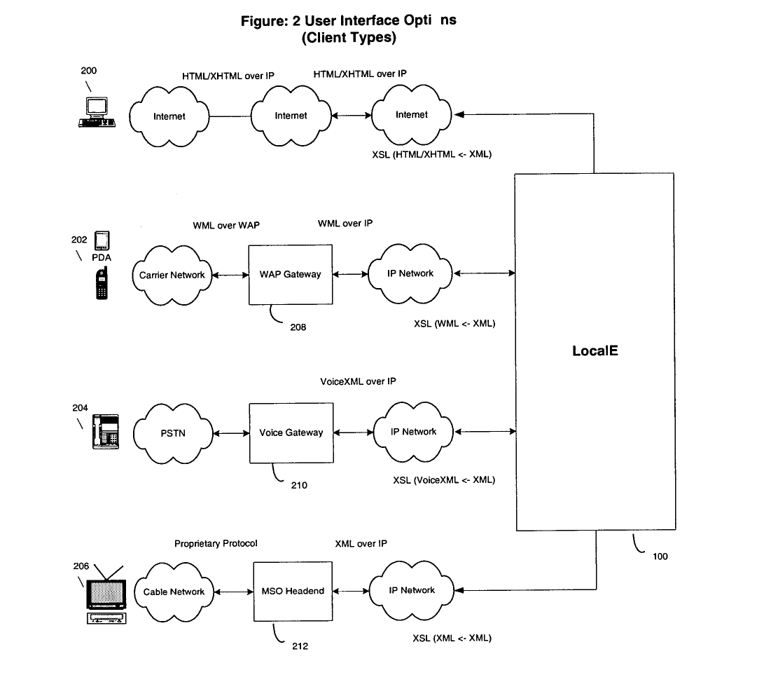

As shown in FIG. 1, the system 100 of the invention serves three types of users, or roles: consumers, service providers, and administrative personnel. As illustrated in FIG. 2, the users of the system 100 can interact with the system 100 via any one of a number of client types, including:
a Web/Hypertext Transfer Protocol (“HTTP”) Client 200 such as a personal computer (“PC”) with a Web browser connected to the Internet;
a Wireless Application Protocol (“WAP”) Client 202 such as a cell phone or wireless personal digital assistant (“PDA”);
a Voice/Plain Old Telephone System, (“POTS”) Client 204 such as a home or business telephone; and
a Digital Television (“DTV”) Set-top Box (“STB”) Client 206 such as a television set hooked up to cable TV through a DTV set-top box.

As shown in FIG. 2, with the exception of an HTTP (web browser) client that has a direct connection to the Internet, the clients go through gateways for connecting to the system. The wireless clients (cell phones, PDAs, etc.) are shown as going thorough a WAP gateway 208 that applies the necessary transformations (message formats, addresses, etc.) for enabling a WAP client 202 to communicate with an IP host such as the server implementing the invention. Those skilled in the art will appreciate, however, that with the release of WAP 2.0, which includes support for transmission control protocol/Internet protocol (“TCP/IP”) and HTTP, wireless devices can utilize existing Internet technologies directly, without the need of a WAP gateway 208. The POTS clients 204 (Voice/Interactive Voice Recognition [“IVR”]) use a voice gateway 210 as an interface between a telephone carrier's network and an IP based network. The voice gateway 210 includes a Voice Extensible Markup Language (“VoiceXML”) browser. It utilizes voice recognition and the Text-to-Speech (“TTS”) technology for translating incoming data (voice or phone key presses) into text/VoiceXML and converts the outgoing VoiceXML data into voice. Similarly, a cable television Multiple System Operator (“MSO”) Headend 212 serves as an interface between the proprietary cable network and the IP based network.

Software and Hardware Components

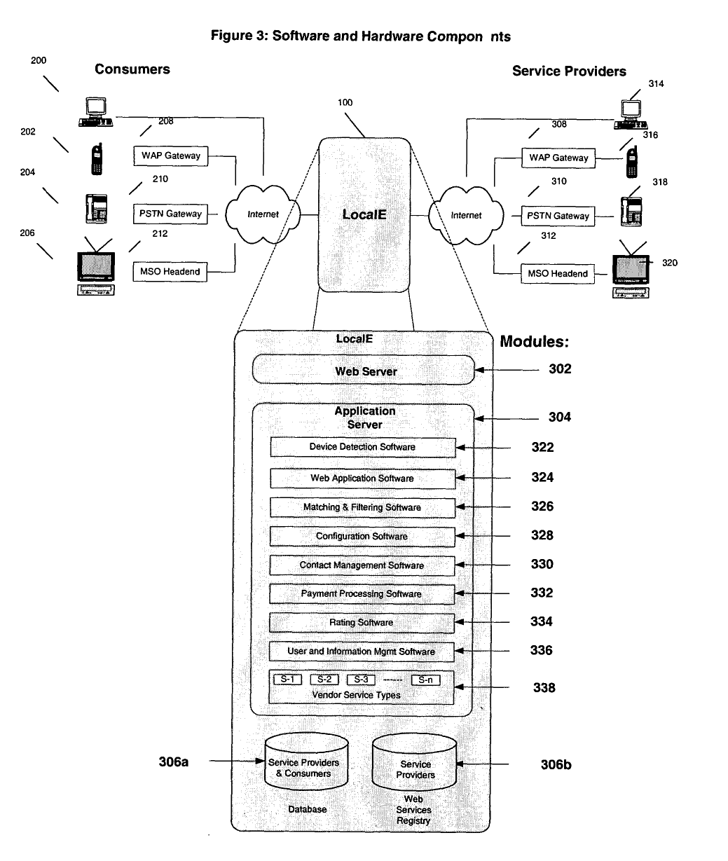

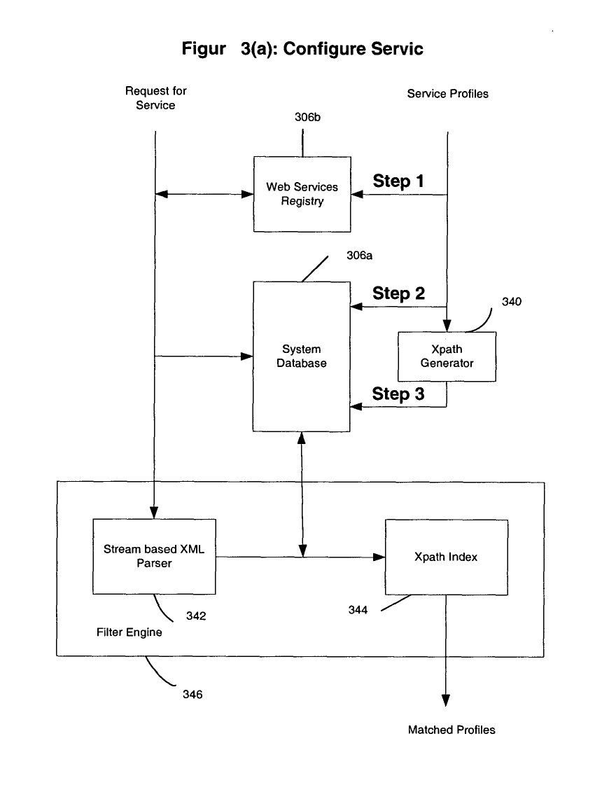

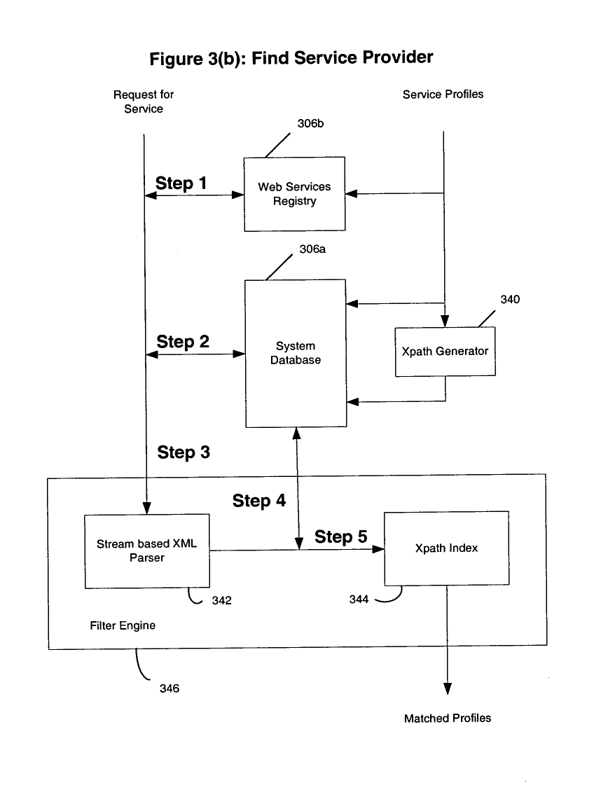

The major software and hardware components of the system 100 of the invention are illustrated in FIG. 3. These components include web server 302, application server 304, data management modules 306a, 306b, and communication gateways 308-312 to service provider clients 314-320. As illustrated, the application server 304 includes device detection software 322, web application software 324, matching and filtering software 326, configuration software 328, contact management software 330, payment processing software 332, rating software 334, user and information management software 336, and vendor services software 338. The data management modules, in turn, include the system database 306a and a Web Services registry 306b, while the gateways include a WAP gateway 308, a voice gateway 310, and an MSO headend 312.

Web Server 302 and Application Server 304

The web server 302 illustrated in FIG. 3 fields all HTTP requests. It maintains and serves all static Hypertext Markup Language/Extensible Hypertext Markup Language (“HTML/XHTML”) data and delegates all dynamic requests to the application server 304. The application server 304, on the other hand, houses the core software components 322-338 of the system. Among other things, the application server 304 provides persistence, transaction, and security support for the following application software components.

Device Detection Software 322

The names of the application software components reflect their purpose. The device detection software 322 illustrated in FIG. 3 determines what type of client (Web, WAP, Voice or DTV) a user may be using to interact with the system 100. In addition to connection and transport protocols, each client type has its own information presentation, display, and navigation requirements. The device detection software 322 caters to these differences. It provides support for adaptation and reformatting of data according to the needs of a specific device type.

Web Application Software 324

The web application software manages a user's interactive session with the system 100. Once the client type of the user has been determined by the device detection software 322, the web application software 324 determines the type of action requested by the user. It validates the user request and, based on the type of action requested by the user, the web application software 324 invokes the other relevant software components 324-338 of the system 100. For example, if the action requested by the user consists of finding a service provider, the web application software 324 passes the request to the matching and filtering software 326. Similarly, if the user wants to configure a service the web application software invokes the configuration software 328.

Vendor Services Software 338

An embodiment of the invention is implemented using Web Services. In the current state of technology, Web Services are often described as a set of XML based standard software artifacts and protocols that when implemented and exposed according to a set of guidelines are said to form a Web Service. The current standards include: Web Services Description Language (“WSDL”); Simple Object Access Protocol (“SOAP”); and Universal Description, Discovery and Integration (“UDDI”) or the Electronic Business using eXtensible Markup Language (“ebXML”) Registry. Instead of tying the notion of Web Services to industry standards that are popular today, the description of the present invention herein adopts a more general definition of Web Services. The definition adopted here is consistent with that of the World Wide Web Consortium (“W3C”). The W3C defines Web Services as follows:
“A Web Service is a software system identified by a Uniform Resource Identifiers (“URI”—a.k a. Universal Resource Locators “URLs”), whose public interfaces and bindings are defined and described using XML. Its definition can be discovered by other software systems. These systems may then interact with the Web Service in a manner prescribed by its definition, using XML based messages conveyed by internet protocols.”

According to this view, a class of vendor services, such as plumbing, is an interface described by a service description and its implementation is a software module deployed on the system and is identified by a URL. It manages a set of service profiles that belong to individual service vendors (i.e., plumbers). Each service profile comprises a set of attributes describing their offerings which among other things may include one or more URLs of its own.

The service description contains the details of the interface and its implementation. This includes its data types, operations, binding information, and network location. It could also include categorization and other meta data to facilitate discovery and utilization by requestors. The complete description may be realized as a set of XML description documents. The service description may be published to a requestor directly or to a discovery agency.

Three different roles can be identified with each Web Service: the provider; the consumer; and the registry or the discovery agency. The service provider is the entity that creates the Web Service. For example, the provider of a plumbing Web Service in the system described herein would be the system personnel. From this perspective, the system personnel are responsible for creating the Web Service. Creating a Web Service entails two actions on the part of the service provider. First, the provider describes the Web Service in a standard format. Second, to expose the service to a wider audience, the service provider publishes the details about the Web Service in a central registry that is publically available to everyone.

Anyone who uses the Web Service is called a consumer of the Web Service. The service consumer can know the functionality of a Web Service from the description made available by the provider. To retrieve these details, the service consumer does a lookup in the registry to which the service provider had published its Web Service description. More importantly, the service consumer is able to get from the service description, the mechanism to bind to the Web Service provider's Web Service and in turn to invoke the Web Service. In terms of the system described herein, the consumers of a plumbing Web Service are the plumbers who use this system's configuration software to configure or define a new plumber profile. Those in need of a plumbing service, i.e., the potential buyers of the plumbing service, are also among the users of the plumbing Web Service. They use the system's matching and filtering software 326 to find the plumbers in their community.

A service registry 306b is a searchable set of service descriptions where Web Sservice providers publish the descriptions. The service consumers can find and then bind to the Web Service. The Web Service discovery agency or the registry can be centralized or distributed.

The system personnel are responsible for creating new service types and registering them with registries. The system is designed to hold a variety of home, technical, business, and educational services. Examples include: babysitting; cleaning; wallboard; electrician; carpenters; lawyers; lawn and garden; painting; software support; hardware support; typing; accounting; and many more. Those skilled in the art will appreciate that many such services too numerous to mention here may be implemented using the techniques of the invention.

The core of the system of the invention comprises a collection of software components (or Web Services as just described) that embody vendor businesses or their service offerings 338 (S-i, i=1 . . . n in FIG. 3). Each service/business type, such as plumbing or landscaping, is implemented as a Web Service. A Web Service manages a set of service profiles that belong to individual service vendors (i.e., plumbers). A description of Web Services with respect to their exemplification in this system is provided in detail below. The other software components implemented as Web Services include matching and filtering software 326, configuration software 328, contact management software 330, payment processing software 332, and rating software 334. These components are described below.

Configuration Software 328

The service providers use the configuration software 328 to describe their service offerings to the system 100 and make them accessible by the consumer community at large. The pertinent aspects of the service configuration software 328 are shown in FIG. 3(a). Part of the process of configuring a new service includes collecting information from service providers about their service offerings. The system 100 uses this information to create service profiles and register them with the Web Services registry 306b (FIG. 3a, Step 1). The service profiles are coded as XML documents. Only a handful of parameters of a service profile are stored in the registries. These parameters include: owner's name, address, the North American Industry Classification System (“NAICS”) or the D&B unique nine-digit sequence (D-U-N-S® or “DUNS”) classification of the service, and one or more URLs that points to the service profile. The complete profiles are stored in database 306a maintained by the system 100. The process of storing service profiles in the system database 306a is shown as Step 2 in FIG. 3(a).

As will be described in detail in a section to follow, the matching of consumer requests with service profiles is based on a filtering technique. The filtering software 326, instead of searching the raw XML profiles for matches with consumer needs, relies on an index structure developed from the XML Path Language (“XPath”) queries corresponding to the XML profiles.

The XML profiles are run through a special XPath generator 340. The XPath generator 340 develops XPath expressions (or queries) that match the XML profiles. It then decomposes an XPath query into a set of path nodes. The path nodes are used to develop an XPath index 344 for the XPath expression. The nodes of XPath expression serve as the states of the finite automaton of the Filtering Engine (“FE”) 346. The process of generating the XPath expressions and then developing an index from the XPath nodes is shown as Step 3 in FIG. 3(a).

Matching and Filtering Software 326

The matching and filtering software 326 allows consumers to describe their needs to the system 100 and to find the providers that match their requirements. The software 326 looks for matches not only in the Web Services registries 306b but in the system database 306a as well. In doing so, the system 100 follows an Information Filtering (“IF”) approach as distinguished from a search or the Information Retrieval (“IR”) approach. The part of the process that matches the incoming requests with the service profiles (more specifically, the XPath expressions that serve as the surrogates for the raw XML vendor profiles) is shown as Steps 1 through 5 in FIG. 3(b).

In response to a request for service, which comes to the system as an XML document, the system 100 first looks up the Web Services registry 306b (FIG. 3b, Step 1). The Web Services registry 306b (or the network of registries) is supposed to contain a universal set of businesses or service providers. It is expected that the members of this system 100 will comprise a subset of the larger set as contained in the Web Services registry 306b. The system 100 maintains information about its member businesses only. All members of the system 100 are also registered in the Web Service registry 306b. This is done at the time when a service provider becomes a member of the system 100 and configures his/her offerings using the system 100.

The Web Services registry 306b normally maintains only a few attributes about a business service. The attributes include: business/service classification (e.g., DUNS or the NAICS number), business name, address, contact person, and the endpoint (a URL pointing to where the Web Service is hosted). Compared to the Web Services registry 306b, the system 100 maintains an elaborate profile of the offerings of its members. The profiles include such attributes as the timing/schedule, skills, experience, qualifications, geography or the area of service, payment or settlement methods, references and other service specific and self authored attributes.

The lookup in the Web Services registry 306b is used to retrieve an inclusive set of businesses (members and non-members) in a local area (confined to a zip code). The result of this lookup is the super set of services that could match the needs of a consumer. This result set is used to retrieve the profiles of the business services from the system database 306a (FIG. 3b, Step 2). The business (or the vendor service) profiles are maintained in two forms: as raw XML documents; and as XPath indices. As noted in the previous section, when a vendor configures his/her business offerings an XPath index 344 is generated for the service. With the goal of matching the consumer's need criteria against the business/service profiles, the XML document describing the consumer request is handed to the system's filter engine 346. The filter engine 346 uses a stream based XML parser 342 for parsing the request document (FIG. 3b, Step 3). The XML parser 342 then drives the process of checking for matching profiles in the corresponding XPath Index 344. In this index the elements of the XPath expressions are mapped to the states of a finite state machine (FIG. 3b, Step 4). The parser 342 sends events that are responded to by the event handlers. The events are reported to the handlers through callbacks and are used to drive the profile matching process (FIG. 3b, Step 5). As an example, a transition from an active state of the finite automaton is fired when an element is found in the document that matches the transition. A profile is considered to match a consumer request when the final state of its finite state machine is reached.

Those skilled in the art will appreciate that Information Retrieval (“IR”) and Information Filtering (“IF”) as used herein are two distinct processes having equivalent underlying goals. They both deal with the problem of information seeking. Given some information need presented by the user in a suitable manner, they are both concerned with giving back a set of documents that satisfy the need. An information need is represented via queries in IR systems and via profiles in IF systems. In order to provide users with the requested information, both IR and IF systems must represent the information need (query and profile respectively) and the document set in a manner suitable for comparison and matching.

IR involves retrieval of a set of documents that match a certain query from a collection of documents. The retrieved documents are then rank ordered and presented to the user. In this model, a user with some information need presents a query to the IR system. As explained herein, the query is a representation of the user's information need in a language understood by the system. The query is then matched against documents, which are organized into text surrogates (e.g., list of keywords, or titles, or abstracts). Text surrogates can be viewed as a summarized structured representation of unstructured text data; thus, they provide an alternative to original documents as they take far less time to examine and at the same time encode enough semantic cues to be used in query matching instead of the original documents. As a result of IR matching, a set of documents would be selected and presented to the user. The user either uses those documents or gives some feedback to the system resulting in modifications in the query (relevance feedback), original information need or, rarely, the surrogate. This interactive process goes on until the user is satisfied or until the user leaves the system.

IF systems deal with streams of incoming documents usually broadcasted via remote sources. The system 100 of the invention maintains profiles for users. The profiles describe long-term interests of the users. Profiles may describe what the user likes or dislikes. New incoming documents are matched against user profiles. Only those documents that match users' profiles are routed to the users. As a result, the users only view those documents that meet their needs as reflected in their profiles.

The first step in using an IF system is to create a profile. A profile represents the user's information needs, which are supposed to be stable over a long period of time. Whenever a new document is received through the data stream, the system 100 represents it as text surrogates and compares it against every profile stored in the system. If the document matches a profile, it is routed to the corresponding user. The user can then use the received documents and/or provide feedback. The feedback provided may lead to modifications in the profile and/or information need.

The system 100 described here is modeled as an IF system. The XML documents that represent the vendor services profiles are the analogs of the user needs discussed above. The vendors who expect to receive leads express and submit their interests to the system 100 as profiles of their service offerings. In principle, the incoming requests for services are matched against the vendor profiles. For the sake of speed and scalability however, instead of matching the incoming requests against the raw profiles, the request for services are matched against the indexes built from the XPath expressions corresponding to vendor profiles. The XPath expressions are the surrogates of the raw XML profiles. The indexes of XPath expressions (or XPath queries) are constructed for each vendor profile when they are originally described to the system 100. This process is depicted as Steps 1 through 3 of FIG. 3(a) above. Variations on the finer details of the IF technique described above are known to those skilled in the art and will not be elaborated upon here.

Contact Management Software 330 and Payment Processing Software 332

From the result set of the providers that match a consumer's needs, the consumer can select one or more providers and tell the system 100 that he/she would like their needs to be known to the providers. The system 100 is responsible for contacting the selected providers and letting them know about the nature of services being sought by the consumer. Each such contact carried out by the system 100 presents a potential business opportunity to the vendors. The system 100 allows the vendors to either accept or reject the business opportunity. An acceptance of the business lead by a vendor allows the vendor to gain access to the consumer information including how to get in touch with the consumer. Those who choose not to accept the offer lose the potential business, as they are not told who might be in need of what they have to sell. The application software that supports this protocol is called the contact management software 330 and, as its name suggests, the payment processing software 332 is responsible for making sure the vendors who accept the leads are charged the lead fee.

In a preferred embodiment, the contact management software 330 is capable of converting text to voice, and voice back to text to facilitate the communications with the vendors. The text-to-speech capability is used to convert the user needs typed as text over the web into voice, which is then delivered to the vendors over the telephone. The text-to-speech process takes XML/XHTML as input and converts it into VoiceXML. The VoiceXML is then converted into voice and delivered to the user over the telephone. The reverse process accepts vendor's spoken words over the telephone (cell or POTS) as input and uses a speech synthesizer (not shown) to transform the voice into VoiceXML. The VoiceXML is then converted into XML/XHTML, which is then used to instruct the system 100 to take the appropriate action.

Rating Software 334

The rating software 334 allows the consumer to provide his/her opinion of the quality of the work performed or the services rendered by the vendor. The vendors also can use this software 334 to give their opinion about how consumers dealt with them.

User and Information Management Software 336

The objective of the user and the information management software 336 is to maintain a database of its users (both service providers and consumers), vendor service profiles, request and contact status, payment details, business leads, etc.

Use Cases

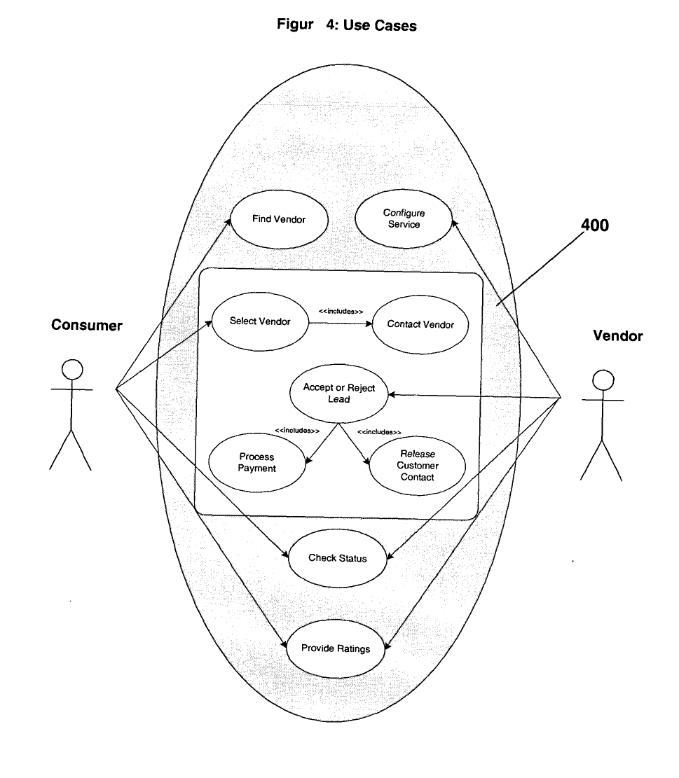

A series of use cases will now be described with reference to FIGS. 4-24 in order to explain the operation of the system 100. In particular, operation of the system 100 when a consumer makes the following requests is described:
Configure Request
Select Service
Contact Vendor
Check Status
Provide Ratings
as well as when a vendor makes the following requests:
Configure Service
Accept or Reject Leads
Process Payment
Release Customer Contact
Check Status
Provide Ratings.

As shown in FIG. 4, the Select Vendor use case of the consumer includes the Contact Vendor use case. The Contact Vendor use case takes effect automatically as a consequence of the selection of vendors by the consumer. Subsequently, as vendors are contacted by the system 100 (i.e., vendors receive leads), the vendors can either accept or reject the lead. That means, the Accept or Reject use case of the vendor is dependent upon the Contact Vendor use case of the consumer. These use cases are shown in the rounded rectangle 400 inside the system boundary in FIG. 4. Namely, these use cases are: Contact Vendor, Accept or Reject a Lead, Process Payment and Release Customer Contact. It should be apparent that the Select Vendor use case of the “Consumer” is the outer most use case among the ones shown inside the rounded rectangle. Therefore, in the discussion to follow these use cases are described under the heading of Select Vendor use case.

Use Case Workflows and their Implementation

As noted above, the system 100 provides four different ways to interact with it. Potentially, this translates into four scenarios (or workflows) for each use case. For example the Find Vendor use case has a separate workflow for each of the following clients: Web, WAP, Voice, and the DTV. This is also the case for the Select Vendor, Check Status, and the Provide Ratings use cases. Each scenario can entail very unique activities, events, decision points and assumptions.

TABLE 1
PRIMARY USE CASES

| | | INCLUDED | | USER INTERFACE OR | | | |
|---|---|---|---|---|---|---|---|
| PRIMARY | | OR | | CLIENT TYPE ACTIVITY | | | |
| USE CASE | | DEPENDENT | | DIAGRAM NUMBER | | | |
| ID | Name | USE CASE | ACTOR | Web | Voice | WAP | DTV |
| 1 | Configure | | Vendor | CS-1 | | | |
| | Service | | Customer | | | | |
| | | | Service | CS-2 | | | |
| | | | Rep | CPS- | | | |
| | | | (CSR) | GUI-1, 2 | | | |
| 2 | Find | | Customer | FS1 | FS-2 | FS-3 | FS-4 |
| | Service | | | FPS- | | | |
| | | | | GUI-1, 2, 3 | | | |
| 3 | Select | Contact | Customer | SV-1 | SV-2 | SV-3 | SV-4 |
| | Vendor | Vendor | | | | | |
| | | Accept or | Vendor | | | | |
| | | Reject Lead | | | | | |
| | | Process | Vendor | | | | |
| | | Payment | | | | | |
| | | Release | Vendor | | | | |
| | | Customer | | | | | |
| | | Contact | | | | | |
| 4 | Check | | Customer | CST-1 | CST-2 | CST-3 | CST-4 |
| | Status | | Vendor | SPS-GUI-1 | | | |
| 5 | Provide | | Customer | PR-1 | PR-2 | PR-3 | PR-4 |
| | Ratings | | Vendor | | | | |

Table 1 shows that the primary use cases, numbered ID 1 through ID 5 in the first column of the table, are:
1. Configure Service;
2. Find Service;
3. Select Vendor;
4. Check Stats; and
5. Provide Ratings.
   Separation of User Interface from Implementation

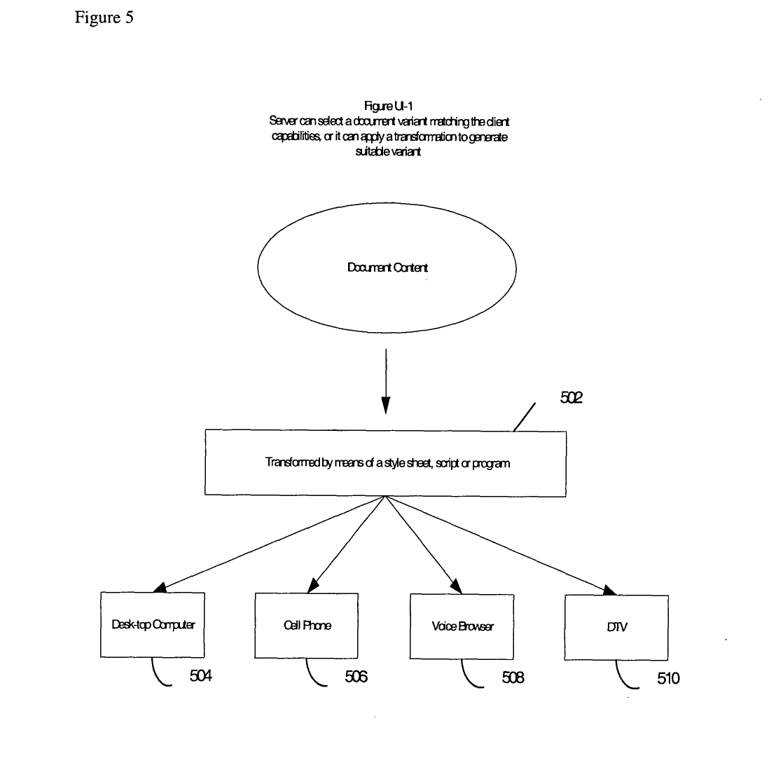

An important feature of the system 100 is that the software implementation of each use case, beyond the point of User Interface (“UI”) is alike for each device type. The system 100 thus makes use of the modem software technologies to separate the UI related software components from the business logic and the data components. In this regard, the system 100 uses a Model-View-Controller design pattern. The benefit of Model-View-Controller based architecture is that a common set of controller (i.e., business logic) and the model (i.e., data) components are used to serve various UI clients or device types. The differences lay in the implementation of the view related components. In other words, each device type has its own information presentation and display components, yet all of them use the same business logic and data components. As shown in FIG. 5, the system also may make use of technologies (e.g., XHTML family of documents) that allow the handling of display and presentation details in a consistent manner. As illustrated in FIG. 5, a server can select a document variant matching the client capabilities, or it can apply a transformation 502 by means of, for example, a style sheet, script, or program, to generate a suitable variant for the consumer's display device 504-510.

Regardless of the client type (Web, WAP, POTS, or DTV), all user requests first arrive at the web server 302 as HTTP requests (e.g., HTTP commands such as, GET, POST, etc.). Unless the request is for a static HTML/XHTML page, the web server 302 passes the request on to the application server 304. The web application software 324 of the application server 304 checks to see if a session has been established for the user. If no session exists, the web application software 324 creates a new session for the user and calls the device detection software 322 to determine the device type of the user (PC, Cell Phone, PDA, POTS, DTV, etc.). Once the device type is determined, the web application software 324 determines the nature of the user request and decides what action it needs to take. This aspect of the system 100 remains the same for each request within a use case. Therefore, in order to avoid the redundancy, the implementation details of the use cases to be described in the sections to follow will not repeat the device detection aspect of the system just described.

The sections to follow each describe a single primary use case. Each use case is first described with the help of an activity or the workflow diagram. Where relevant, the workflows are augmented with user interface (UI) snapshots. The implementation details of each use case are described next.

As shown in Table 1 above, since each use case can potentially have four UI options (Web, WAP, POTS & DTV), the sections to follow include UI specific activity diagrams for each use case. For the reasons described above, the implementation details make little to no reference to the UI differences due to device types. Individual sections do not include UI snapshots for each device type. Instead, for the sake of simplicity, the UI snapshots are included only for a personal computer client with a web browser.

For ease of reference the entries in the last four columns of Table 1 above show the IDs assigned to the activity diagrams and associated UI snapshots for each use case. For example, the four workflows of the Find Service use case are described as Figure FS-1, FS-2, FS-3, and FS-4. The Graphical User Interface (“GUI”) snapshots for this use case are shown as Figures FPS-GUI-1, 2 & 3.

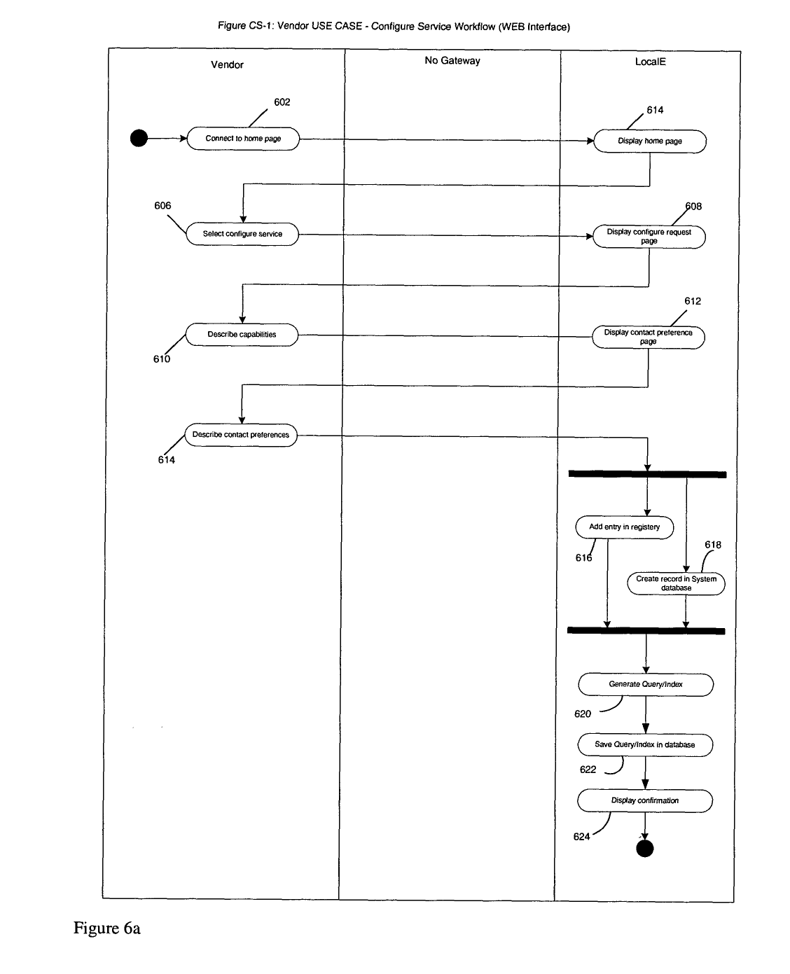

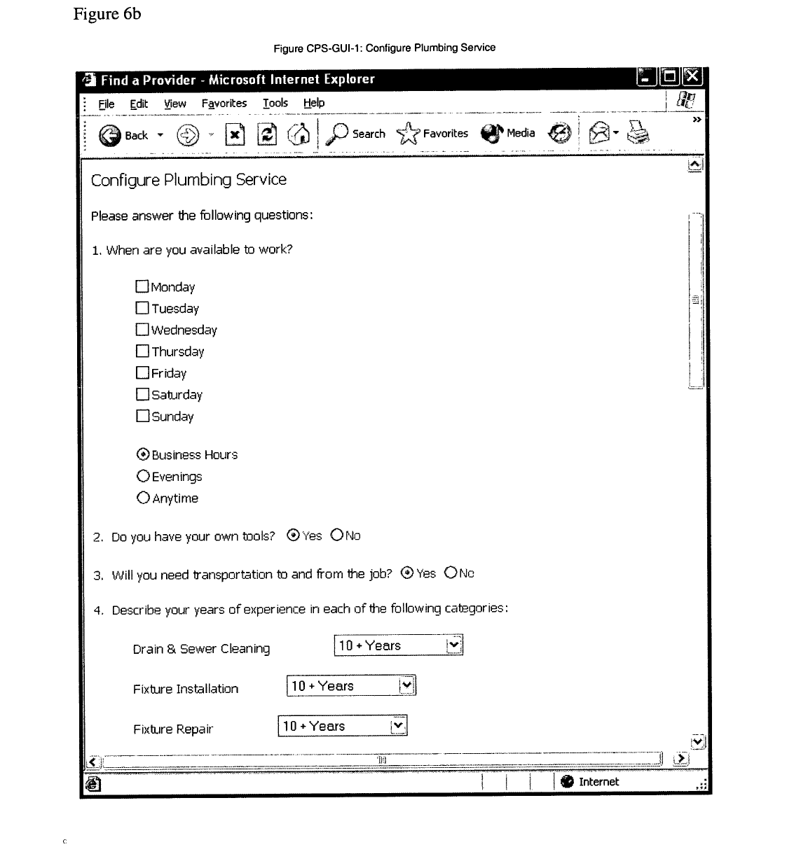

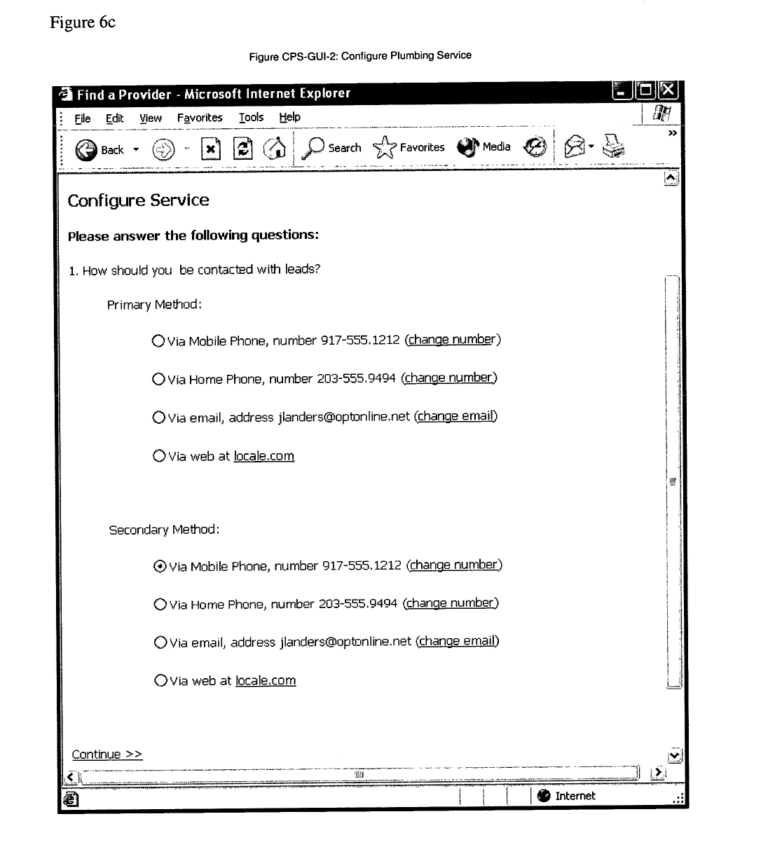

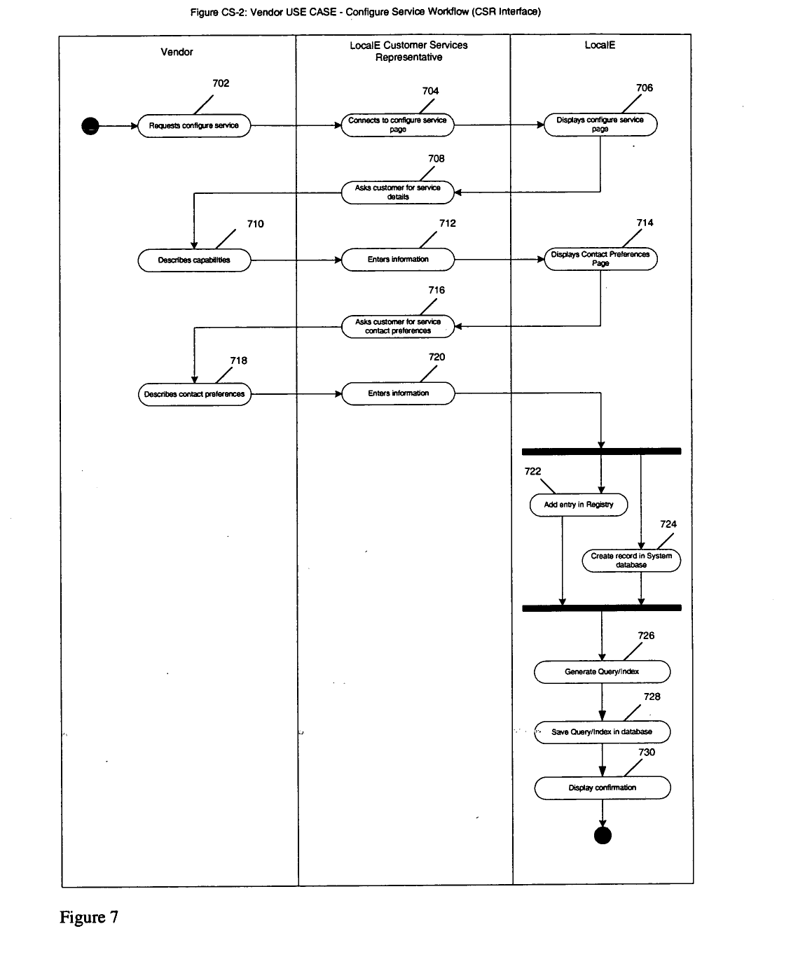

Configure Service (FIGS. 6 and 7)

The vendor services may be configured along some or all of the following parameters:
Time and schedule
Skills, experience, licensing, and other qualifications
Location and geography
Price and settlement method
Contact information
References
Other self authored information (this may include web site address of the vendor service).

A vendor may use the system himself/herself to configure his/her service(s) or, conversely, he/she can have a Customer Services Representative (“CSR”) do it for him/her. Of the four UI options, the configure service use case is best implemented with the web interface.

Configure Service Workflow—Web Interface CS-1 (FIG. 6)

As illustrated in FIG. 6a, a vendor configures his/her service on the system through a web interface by connecting to the system home page (602) to see the home page displayed (604) by the system 100. The vendor selects Configure Service (606) and, in response, the system displays the Configure Service Page CPS-GUI-1 (FIG. 6b) at 608. The vendor then describes his/her capabilities (610) in the Configure Service Page and submits the request to the system 100. The system then displays a contact preferences page CPS-GUI-2 (FIG. 6c) at 612 and the vendor provides contact preferences (614). The system 100 then creates records in the Web Services registry (616) and the System database (618) as described above. The system also creates a query/index (FIG. 3a) (620) and saves the query/index in the system database (622). The system then displays a confirmation page in a conventional fashion (624).

Configure Service Workflow—CSR Interface CS-2 (FIG. 7)

As illustrated in FIG. 7, a vendor may configure his/her service on the system 100 through a phone or some other means by requesting a CSR to configure service (702). The CSR connects to the configure Service Page (704) and the system 100 displays the Configure Service Page CPS-GUI-1 (FIG. 6b) at 706. The CSR asks the vendor for service details (708) and the vendor describes his/her service capabilities (710). The CSR enters the information (712) and the system 100 displays the contact preferences page CPS-GUI-2 (FIG. 6c) at 714. The CSR asks the vendor his/her preferred means of contact (phone, email, etc.) at 716 and the contact preferences are provided by the vendor (718). The CSR enters the information (720) and the system 100 records the information in the Web Services registry 306b (722) and the system database 306a (724) as described above. The system 100 also creates a query/index (FIG. 3a) (726) and saves the query/index in the system database 306a (728). The system 100 then displays a confirmation page in a conventional fashion (730).

As described above, in addition to a common set of parameters, when configuring a service, the vendors are asked to provide answers to a variety of questions that are specific to the type of service he/she wishes to configure. CPS-GUI-1 (FIG. 6b) and CPS-GUI-2 (FIG. 6c) show some of the configuration parameters for a plumbing service. Due to the limited size of the computer screen, and hence the small amount of information that can be captured in a web browser snapshot, the figures show only a subset of the plumbing service parameters. In a live system, the browser page can be scrolled down to view the rest of the plumbing attributes. By way of example, the following is a sampling of questions related to plumbing:
What is plumber's availability (day of the week, hours, etc.)?
Does the plumber have his own tools?
Will the plumber need transportation to and from the job?
Years of experience with different job categories (drain & sewer cleaning, fixture installation, fixture repair, water heater repair/replacement, septic line installation, septic line maintenance, septic line repair, utility line and pipe location, water heater repair, water pipe installation, water pipe repair, and wells and water treatment, etc.).
The area within which the plumber works (miles radius, within zip code, etc.).
Minimum hourly rate (for ½ day, 1 day, 5 day or a 10 day job).
Is the plumber insured? If yes, amount?
Is the plumber a member of a union?
Is the plumber licensed?
The plumber can also provide any additional qualifications or requirements.
The plumber can also specify how would he like to be contacted when a business lead needs to be brought to him.

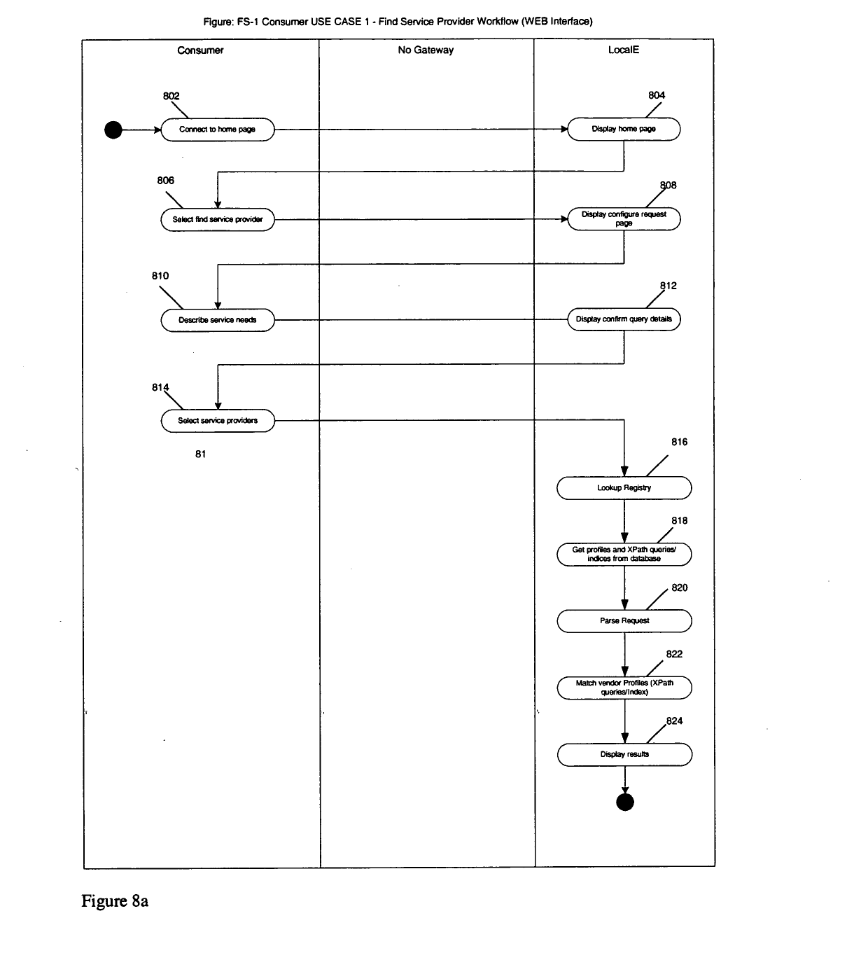

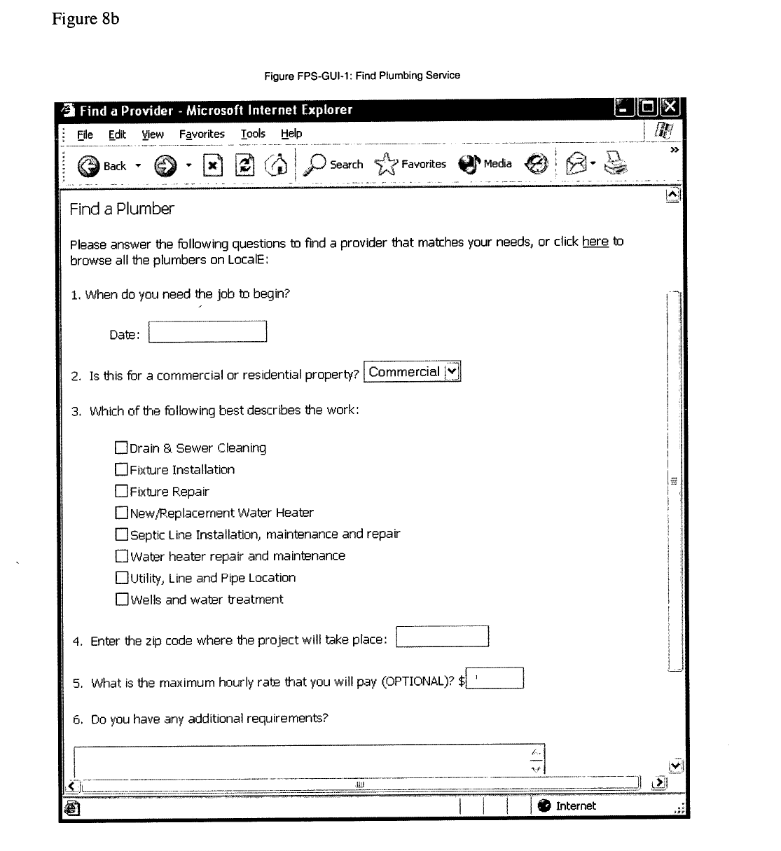

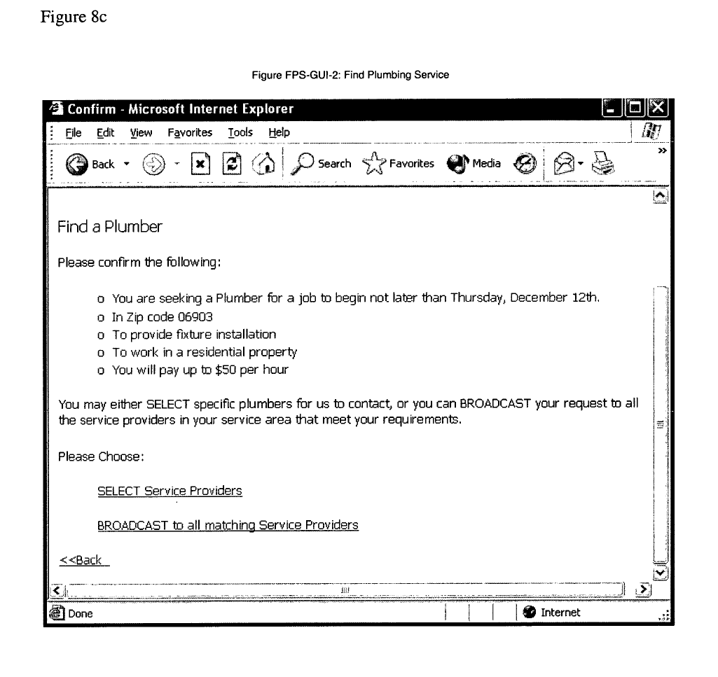

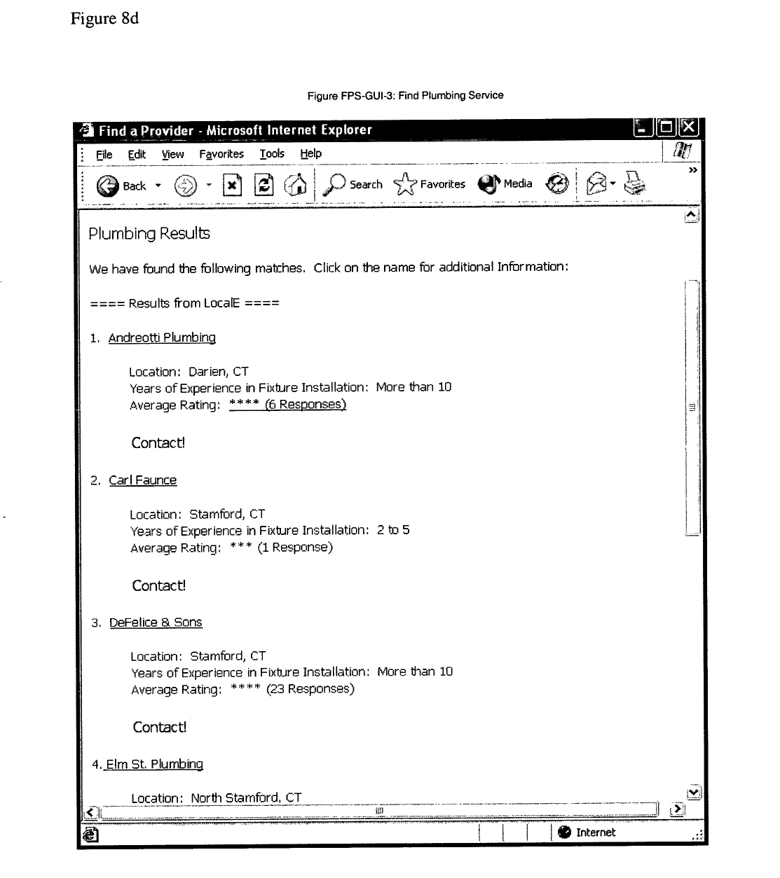

The following is a list of system functions needed for provisioning a new service based on service attributes captured from the vendor:
1. An HTTP request (such as a POST command) delivers the service attribute data to the application server 304.
2. The service attributes are then passed to the web application software 324 as XHTML form data.
3. The web application software 324 determines the action required by the HTTP request and passes the data (either as an XML document or as a serialized object) to the configuration software 328.
4. The configuration software 328 determines the type of service for which a new profile needs to be created.
5. Having determined the type of the service (e.g., plumbing), the configuration software 328 does a registry 306b look up to find the relevant Web Service S-i of 338.
6. Having obtained a handle to the Web Service, the configuration software 328 then requests the Web Service 338 to create a new profile.
7. The Web Service 338 creates the new profile.
8. The configuration software 328 adds an entry for the vendor service in the Web Services registry 306b.
9. The configuration software 328 creates a record for the service in the system database 306a.
10. The configuration software 328 asks the Web Service 338 to generate the XPath query and the corresponding XPath Index (FIG. 3a).
11. The Web Service 338 uses the XPath generator to generate the query.
12. The Web Service S-i of 388 saves the query and the index in the system database 306a.
   Find Service (FIGS. 8-11)

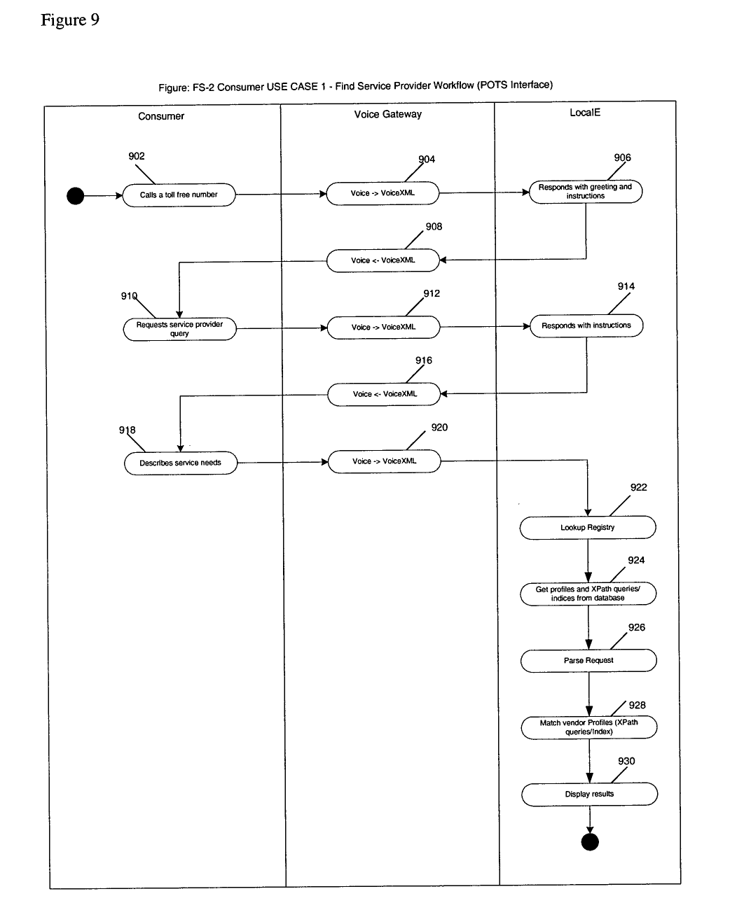

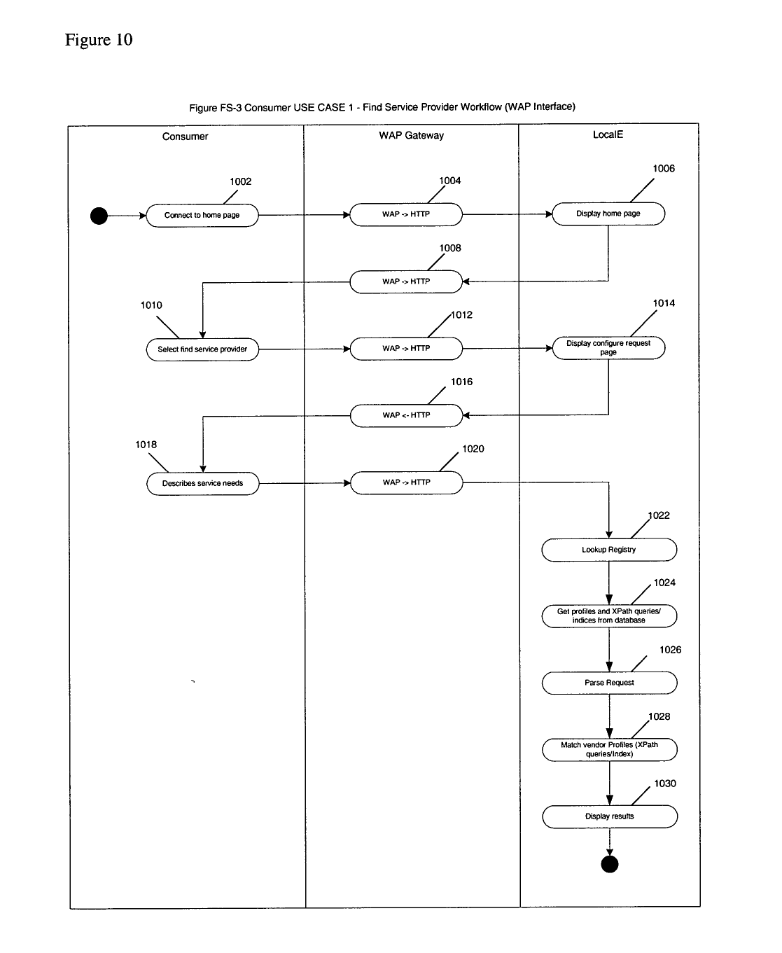

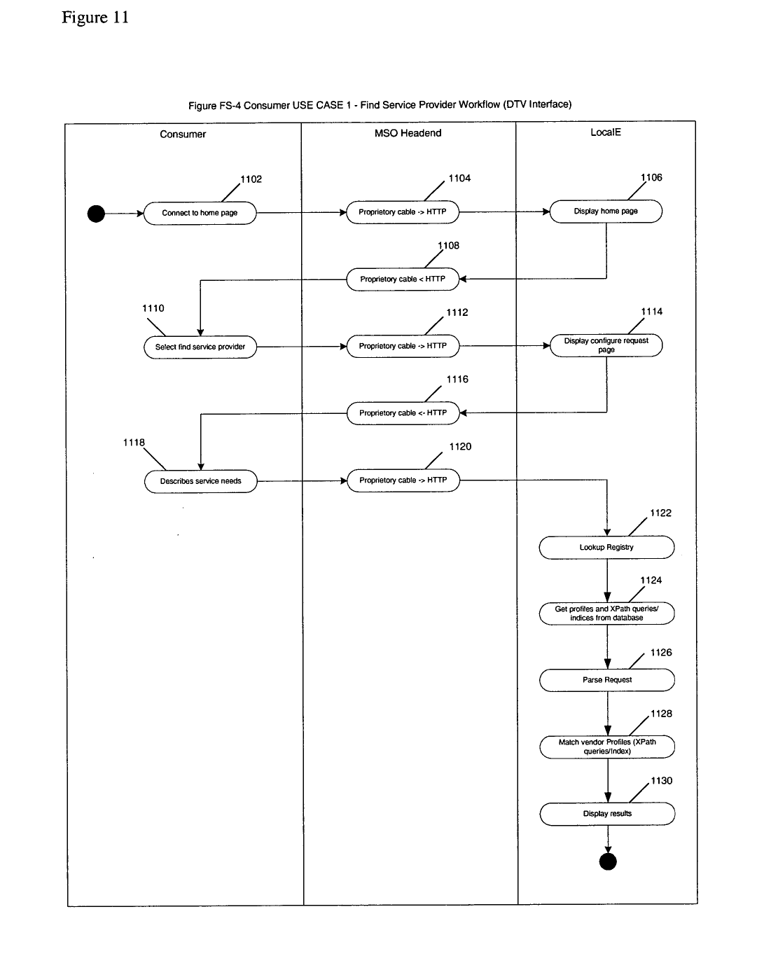

The consumer defines the nature of his/her service need using, for example, the following parameters:
Time and schedule
Skills, experience, licensing, and other qualifications
Location and geography
Price and settlement method
Contact information and preferences
Service specific attributes
Other self authored requirements
   As noted above, this use case has four scenarios:
Web Interface (FIG. 8)
POTS Interface (FIG. 9)
WAP Interface (FIG. 10)
DTV Interface (FIG. 11)

Each of these scenarios will now be described.

Find Service Workflow—Web Interface FS-1 (FIG. 8)

As illustrated in FIG. 8a, a consumer may find a service via a web interface by connecting to the system home page (802) displayed by the system 100 (804) and selecting “find service provider” (806). The system 100 then displays the configure request page FPS-GUI-1 (FIG. 8b) at 808 in which the consumer describes his/her service needs (810). The system displays a confirm query page FPS-GUI-2 (FIG. 8c) at 812. The consumer next opts to select the service providers (814) whereby the system 100 does a lookup (816) in the Web Services registry 306b and retrieves service profiles and XPath queries/indices (818) from the database 306a. The system parses the request for service (820) and matches the request against profiles (XPath queries/indices) at 822. The results are then displayed (i.e., matched service providers) to the consumer on display FPS-GUI-3 (FIG. 8d) at 824.

Find Service Workflow—POTS Interface FS-2 (FIG. 9)

On the other hand, if a consumer elects to find a service via a POTS interface (FIG. 9), the consumer calls a toll free number (902) and is connected to a voice gateway that converts the consumer's voice into VoiceXML (904). The system 100 responds with greetings and instructions (906) and the voice gateway converts the VoiceXML greeting and instructions to voice for presentation to the consumer (908). The consumer then requests a service provider query by voice (910) that the voice gateway in turn converts into VoiceXML (912). The system 100 again responds with instructions (914) that the voice gateway converts from VoiceXML to voice (916). The consumer describes his/her service needs (918) and the voice gateway again converts voice into VoiceXML (920). The system 100 does a lookup (922) in the Web Services registry 306b and retrieves service profiles and XPath queries/indices from the database (924). The system 100 next parses the request for service (926) and matches the request against profiles (XPath queries/indices) at 928. The results (i.e., matched service providers) are then displayed to the consumer on display FPS-GUI-3 (FIG. 8d) at 930.

Find Service Workflow—WAP Interface FS-3 (FIG. 10)

If a consumer elects to find a service via a WAP interface (FIG. 10), the consumer connects to the home page via a WAP gateway using a cell phone or a wireless device (1002). The WAP gateway converts the WAP to HTTP (1004). The system 100 displays the home page to the caller (1006) by using the WAP gateway to convert the HTTP to WAP (1008). The consumer requests the “find service provider” function (1010) and the WAP gateway converts the WAP to HTTP (1012). The system 100 displays the configure request page similar to FPS-GUI-1 (FIG. 8b) at 1014 via the WAP gateway, which converts HTTP to WAP (1016). The consumer describes his/her service needs (1018) and the WAP gateway converts the WAP data to HTTP data (1020). The system 100 uses this data to perform a lookup (1022) in the Web Services registry 306b and retrieves service profiles and XPath queries/indices (1024) from the database 306a. The system 100 next parses the request for service (1026) and matches the request against profiles (XPath queries/indices) at 1028. The results (i.e., matched service providers) are then displayed to the consumer's cell phone as a page similar to FPS-GUI-3 (FIG. 8d) at 1030.

Find Service Workflow—DTV Interface FS-4 (FIG. 11)

If a consumer elects to find a service via a DTV interface (FIG. 11), the consumer connects to the home page via the DTV interface (1102). The MSO headend converts the proprietary cable network protocol to HTTP (1104) and the system 100 displays the home page (1106) via the MSO headend, which converts HTTP to the proprietary cable network protocol (1108). The consumer selects the “find service provider” function (1110) and the MSO Headend converts the proprietary cable network protocol to HTTP (1112). The system 100 displays the configure request page similar to FPS-GUI-1 (FIG. 8b) at 1114 via the MSO headend, which converts HTTP to the proprietary network protocol (1116). The consumer describes his/her service needs (1118) and the MSO headend converts the proprietary cable network protocol data to HTTP data (1120). The system 100 uses this data to perform a lookup (1122) in the Web Services registry 306b and retrieves service profiles and XPath queries/indices (1124) from the database 306a. The system 100 next parses the request for service (1126) and matches the request against profiles (XPath queries/indices) at 1128. The results (i.e., matched service providers) are then displayed to the consumer's DTV as a page similar to FPS-GUI-3 (FIG. 8d) at 1130.

In addition to a common set of parameters, as described at the beginning of this section, consumers can specify their needs by responding to a set of service specific questions. Consumers can describe their special requirements in free form as well. As an example, some need parameters/questions pertaining to a plumbing service, as shown in Figures FPS-GU-1 and FPS-GUI-2, are listed below:
When do you need the job to begin?
Is this a commercial or residential property?
Which of the following best describes the work: drain & sewer cleaning; fixture installation, fixture repair; new/replacement water heater; septic line installation, maintenance and repair; water heater repair and maintenance; utility, line and pipe location; wells and water treatment; and others?
Enter the zip code where the project will take place?
What is the maximum hourly rate that you will pay (optional)?
Do you have any additional requirements?

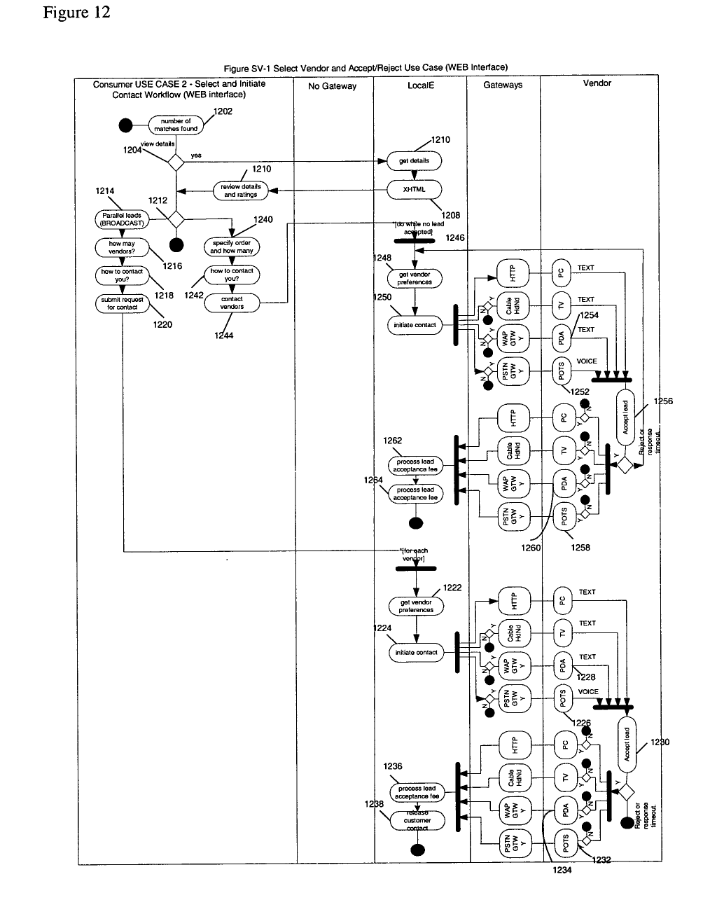

The following is a list of system functions needed for provisioning a new service based on service attributes captured from the consumer.
1. An HTTP request (such as a POST command) delivers the request parameters to the application server 304.
2. The request attributes are then passed to the web application software 324 as XHTML form data.
3. The web application software 324 determines the action required by the HTTP request and passes the data (either as an XML document or as a serialized object) to the matching and filtering software 326.
4. The matching and filtering software 326 determines the type of service being sought by the consumer.
5. Having determined the type of the service (e.g., plumbing), the matching and filtering software 326 performs a web registry look up to find the particular Web Service S-i of 338.
6. Having obtained a handle to the Web Service 338, the matching and filtering software 326 then requests the Web Service 338 to retrieve vendor service entries in a local area from the web registry 306b.
7. The matching and filtering software 326 then instructs the Web Service to pull out service profiles and associated XPath queries/index from the system database 306a.
8. The matching and filtering software 326 asks the filtering engine 346 to look for profiles matching the request for service.
9. The filtering engine 346 uses a stream based XML parser 342 to parse the request.
10. The event handlers catch the events initiated by the parser 342. The handlers drive the process of matching the request parameters against the XPath queries/indices.
11. The matching and filtering software 326 returns a list of matched profiles to the web application software 324.
12. The web application software 324 displays the list of matched profiles as shown in FPS-GUI-3 (FIG. 8d).
   SelectVendor (FIGS. 12-15)

This use case describes the core functionality of the system 100. The Select Vendor use case becomes relevant subsequent to the Find Service use case described above. As a result of the find service query, the consumer gets a list of vendors who are capable and available to meet the consumer's needs. Upon receiving the query results, the consumer can instruct the system 100 to instantaneously inform the providers about the consumer's service needs. The system 100 allows the consumer to specify which ones or how many of the matched providers should be informed of the consumer's needs. The consumer can also specify when, where, and how the providers should get in touch with the consumer.

The system 100 automatically contacts the providers via the means/modes preferred by the providers and shares the business opportunity with them. Without revealing the identity and the contact information of the consumer, the system 100 informs the providers the service needs and requirements of the consumer. At this point, the system 100 asks the providers if they would be interested in pursuing the lead. The service provider is made aware of the fact that if they accept the lead they would be charged a small fee and in return they will gain access to the identity and the contact information of the potential customer. If the service provider chooses to accept the lead, the system automatically charges the fee to the vendor and shares the identity and the contact information of the potential customer with the vendor.

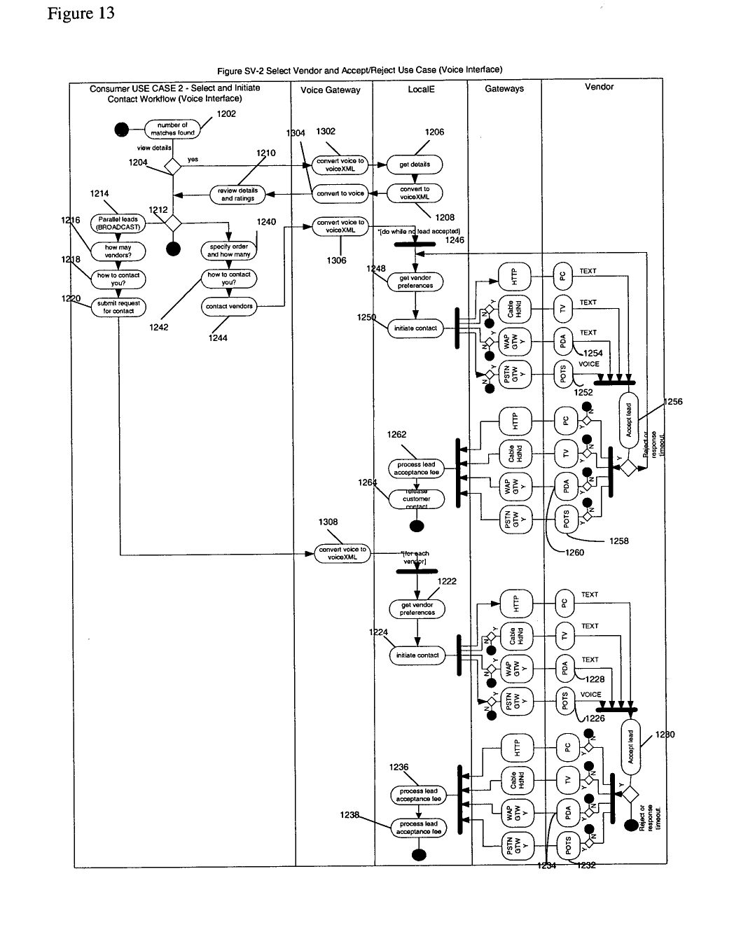

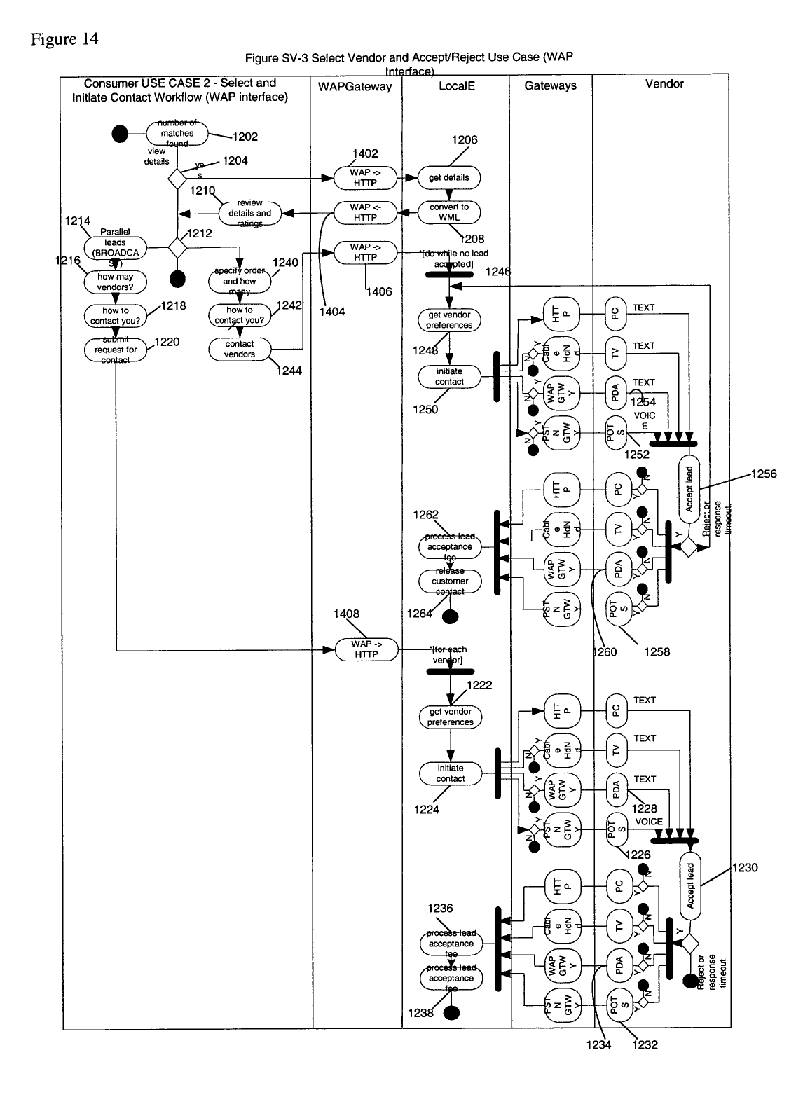

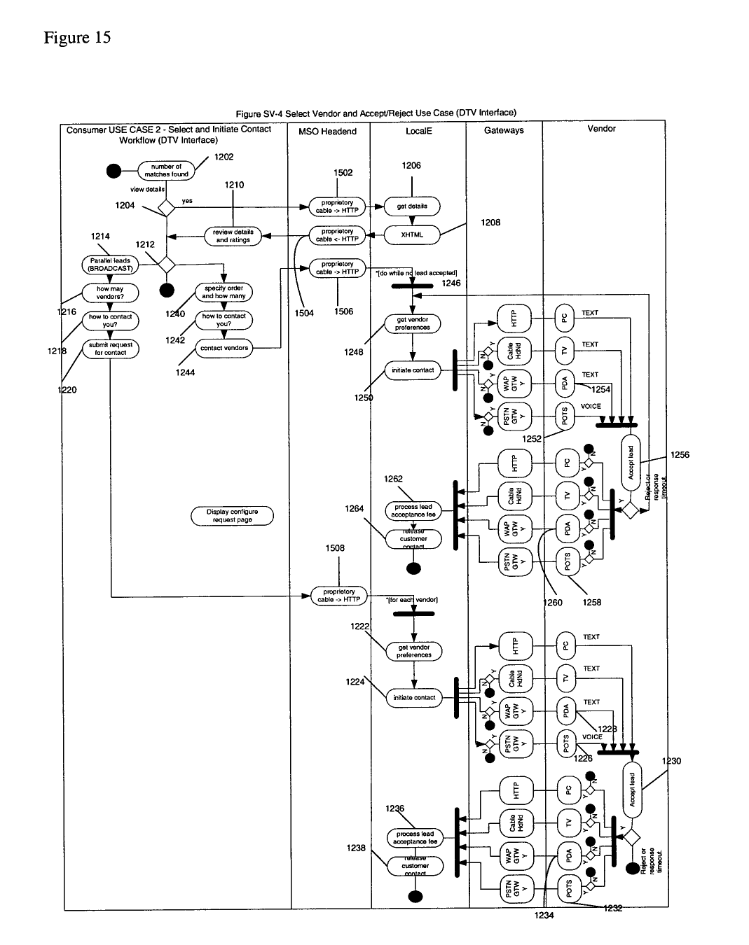

FIG. 4 shows this use case inside the rounded rectangle. As illustrated, there are two primary actors: the consumer and the vendor. In Table 1, this use case is listed as having four scenarios:
Web Interface (FIG. 12)
POTS Interface (FIG. 13)
WAP Interface (FIG. 14)
DTV Interface (FIG. 15)
   Each of these scenarios will now be described in connection with FIGS. 12-15.
   Select Vendor Workflow—Web Interface SV-1 (FIG. 12)

If a consumer elects to select a vendor via a web interface (FIG. 12), the consumer views the list of matched service providers provided via the interface web browser 1202 and elects whether to view detailed information about particular vendors. If the consumer chooses to view vendor details (1204), the system 100 retrieves vendor profile data from the database 306a (1206), converts the data to HTML as necessary (1208), and displays the details for review by the consumer (1210). The consumer also elects whether to broadcast the lead to a few vendors (1212), or to select particular vendors and to specify the order in which the system should contact those vendors. If a broadcast is selected (1214), the consumer specifies the number of vendors to receive the broadcast (1216) and how and when he/she would like to be contacted by the vendors (POTS, cell phone—WAP, DTV, Web, etc.) at 1218, 1220. For each vendor, the system retrieves the vendor preferences (1222) and determines how the vendor would like to be contacted (POTS, cell phone—WAP, DTV, Web, etc.). Then, depending upon the vendor preference, the system applies the appropriate transformation to the message. For example, for POTS—the text is converted to voiceXML by the system 100 which is then converted to voice by the voice gateway (1226). The system 100 retrieves the vendor's telephone number, dials the number (1224), and delivers/plays the voice to the vendor's telephone. On the other hand, for a cell phone, either the text (i.e., XHTML) is converted to voice, or XHTML to WML. For text to voice, the system 100 retrieves the vendor's telephone number, dials the number (1224), and delivers/plays the voice to the vendor's telephone. On the other hand, for XHTML to WML, the system 100 displays the WML on the vendor's cell phone as a text message (1228).

Upon receiving the lead, the vendor can either accept or reject the lead (1230). The vendor may choose to accept or reject the lead through any one of the available devices/interfaces. For example, for POTS, the voice is converted to VoiceXML (1232). The system 100 uses voice synthesis technology to covert the words spoken by the vendor to VoiceXML, which is then used to instruct the system 100 to take the appropriate action. On the other hand, for cell phone communications, the voice is converted to VoiceXML, or WML to XHTML (1234). A cell phone can be used in one of two ways. It can be used to receive voice messages (phone calls) from the system 100 and to send voice commands back to the system 100. On the other hand, it can be used as a WML browser to interact with the system 100. In the case of voice, the cell phone acts similar to a plain old telephone. The system 100 uses voice synthesis technology to convert the words spoken by the vendor to VoiceXML, which is then used to instruct the system 100 to take the appropriate action. In case of WML, the user uses the cell phone keypad to interact with the system 100. In this case, the user commands are converted from WML to XHTML. The XHTML is then used to instruct the system to take the appropriate action. In the case of acceptance by the vendor, the system 100 processes the lead fee (1236) and releases the consumer's contact information to the vendor (1238).

To select and specify the order, the consumer specifies how many vendors should be contacted (1240), including who to contact first, second, third, etc. The consumer also specifies how he/she would like to be contacted and initiates the contact (1242). The system 100 can then start contacting the vendors (1244) and stops contacting the vendors as soon as a vendor accepts the lead (1246, 1256). For any vendor with whom the system initiates a contact, the system retrieves vendor preferences (1248) and determines how the vendor would like to be contacted (POTS, cell phone—WAP, DTV, Web, etc.) at 1248 and, depending upon the vendor preference, the system applies the appropriate transformation to the message. For example, for POTS, the text is first converted to VoiceXML which is then converted to voice (1252) and the system 100 retrieves the vendor's telephone number, dials the number (1250), and delivers/plays the voice to the vendor's telephone. On the other hand, for a cell phone contact, either the text (i.e., XHTML) is converted to voice (1252), or XHTML is converted to WML (1254). For text to voice, the system retrieves the vendor's telephone number, dials the number, and delivers/plays the voice to the vendor's telephone. On the other hand, for XHTML to WML, the system 100 displays the WML on the vendor's cell phone as a text message.

Upon receiving the lead, the vendor can either accept or reject the lead (1256). The vendor may choose to accept or reject the lead through any one the available devices/interfaces. For example, for POTS, the voice is converted to VoiceXML (1258). The system 100 uses voice synthesis technology to covert the words spoken by the vendor to VoiceXML, which is then used to instruct the system 100 to take the appropriate action. On the other hand, for cell phone contact, voice is converted to VoiceXML, or WML is converted to XHTML (1260). The cell phone can be used either to receive voice messages (phone calls) from the system 100 and to send voice commands back to the system 100 or as a WML browser to interact with the system 100. In case of voice, the cell phone acts similar to a plain old telephone. The system 100 uses voice synthesis technology to convert the words spoken by the vendor to VoiceXML, which is then used to instruct the system 100 to take the appropriate action. In case of WML, the user uses the cell phone keypad to interact with the system 100. In this case, the user commands are converted from WML to XHTML and the XHTML is then used to instruct the system 100 to take the appropriate action.

In case of acceptance, the system processes the lead fee (1262) and releases consumer contact information to the vendor (1264).

Select Vendor Workflow—Voice Interface SV-2 (FIG. 13)

With the exception of the intermediary gateway that converts voice to VoiceXML and vice versa (1302-1308), the workflow for the voice interface is similar to the web interface described above with respect to FIG. 12. The workflow for the voice interface is shown in FIG. 13 and is self-explanatory in view of the description of FIG. 12.

Select Vendor Workflow—WAP Interface SV-3 (FIG. 14)

As with the voice interface, with the exception of the intermediary gateway that converts WAP to HTTP and vice versa (1402-1408), the workflow for WAP interface is similar to the web interface described above with respect to FIG. 12. The workflow for the WAP interface is shown in FIG. 14 and is self-explanatory in view of the description of FIG. 12.

Select Vendor Workflow—DTV Interface SV-4 (FIG. 15)

As with the voice interface, with the exception of the MSO Headend that converts DTV to HTTP and vice versa (1502-1508), the workflow for the DTV interface is similar to the web interface described above with respect to FIG. 12. The workflow for the DTV interface is shown in FIG. 15 and is self-explanatory in view of the description of FIG. 12.

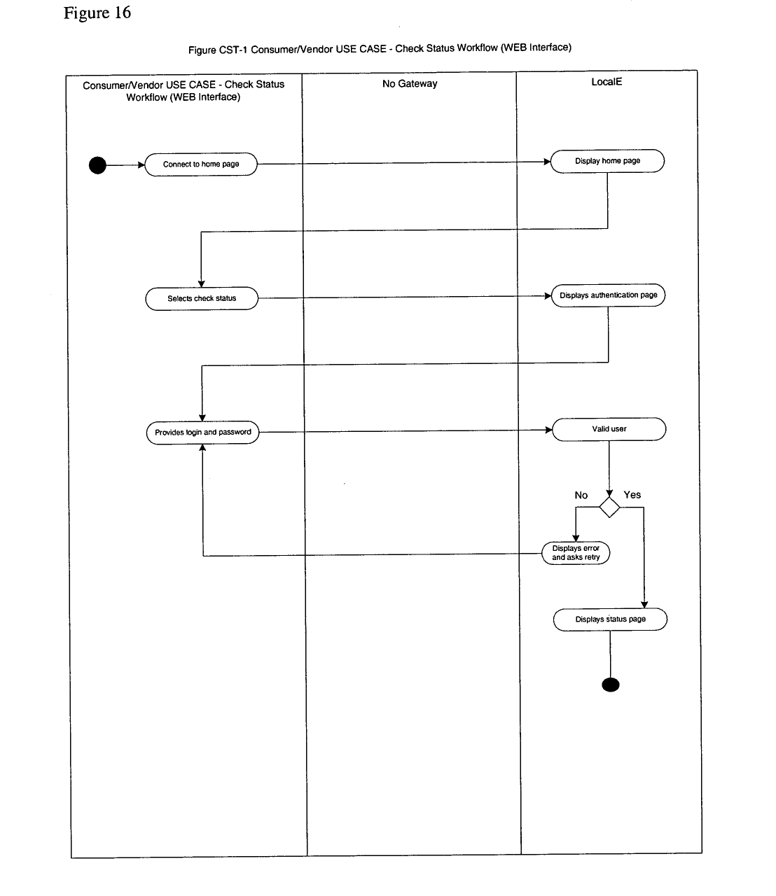

Check Status (FIGS. 16-20)

The Check Status use case applies to both consumers and the vendors. In the case of consumers, the consumers can view the status of their requests. For each request the system provides the following information:
When: The date request was created.
What: The type of service requested.
Who: The vendor.
Status:
   The request awaits an action from the vendor. Example, accepting the lead.
   The request awaits an action from the consumer. Example, provide ratings.

In the case of vendors, the vendors can track their business leads. The system provides the following information for each lead:
When: The date a lead was brought to the vendor.
What: The type of service.
Who: The consumer.
Status:
   The lead awaits an action from the vendor. Example, accepting the lead.
   The lead awaits an action from the consumer. Example, provide ratings.

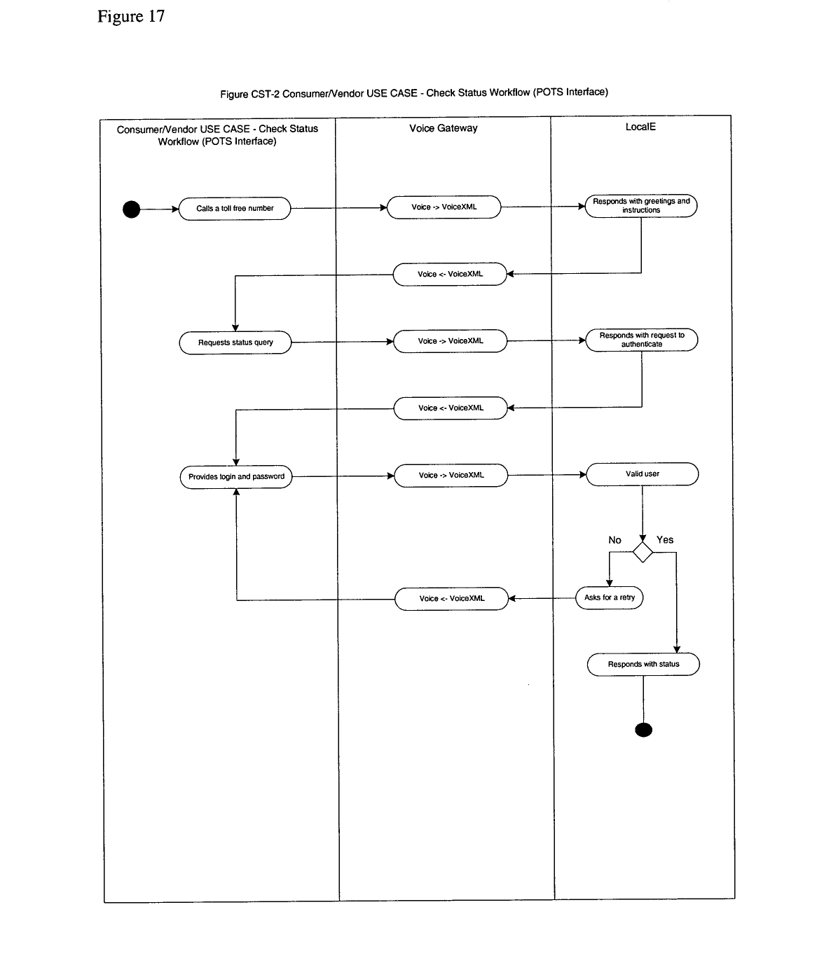

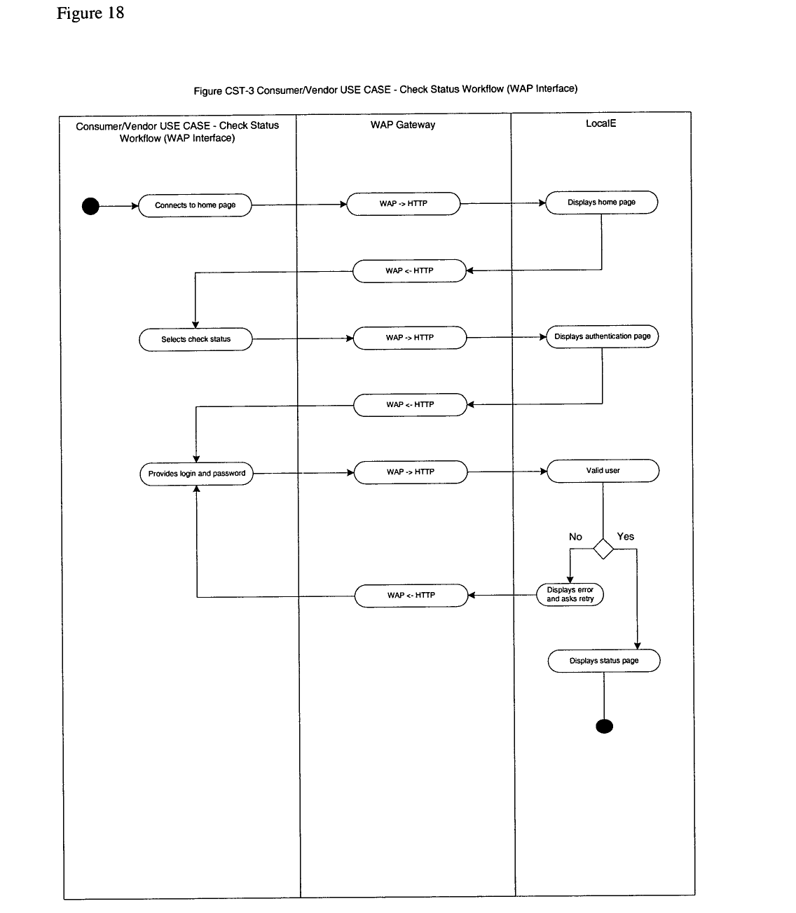

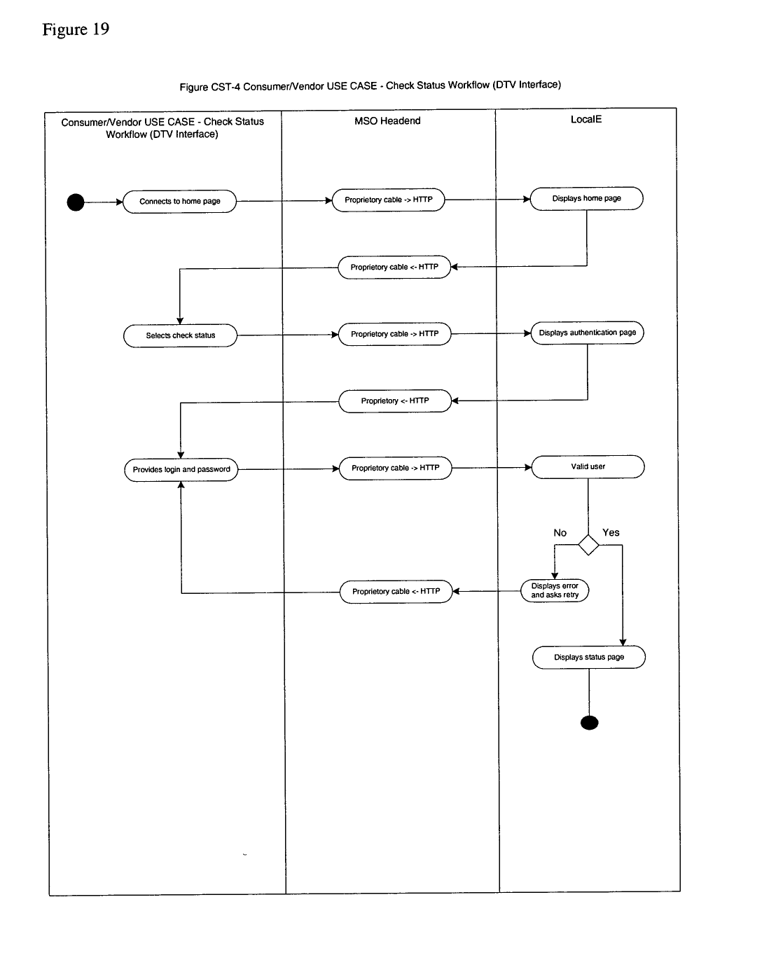

As with the other use cases, this use case has four scenarios:
Web Interface CST-1 (FIG. 16)
POTS Interface CST-2 (FIG. 17)
WAP Interface CST-3 (FIG. 18)
DTV Interface CST-4 (FIG. 19)

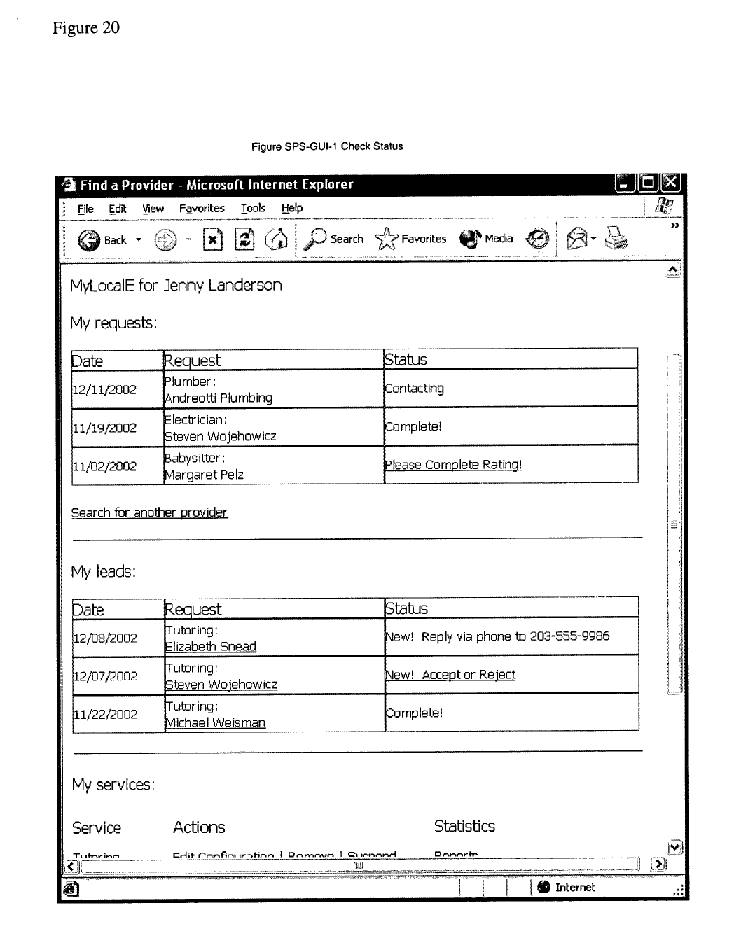

The activity diagrams are self-explanatory. A screen shot of the corresponding web interface is shown as SPS-GUI-1 in FIG. 20.

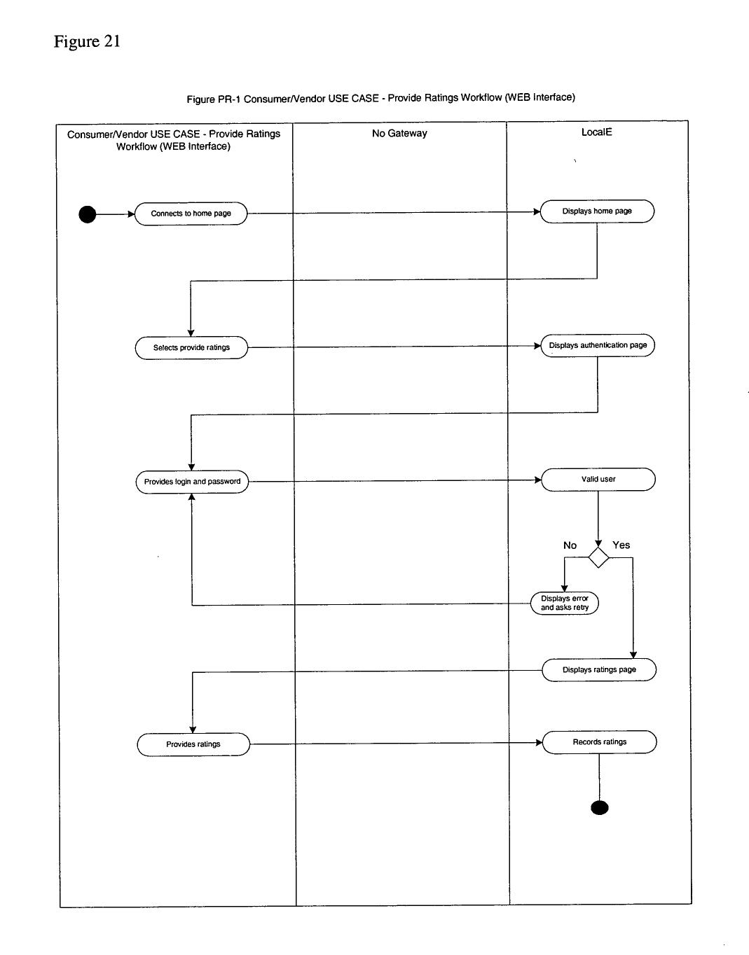

Provide Ratings (FIGS. 21-24)

The Provide Ratings use case applies to both consumers and the vendors.

Once the vendor has rendered the services and the transaction is complete, the consumers can rate the quality of vendor's work and their level of satisfaction. Similarly, the vendors can provide ratings on the customer.

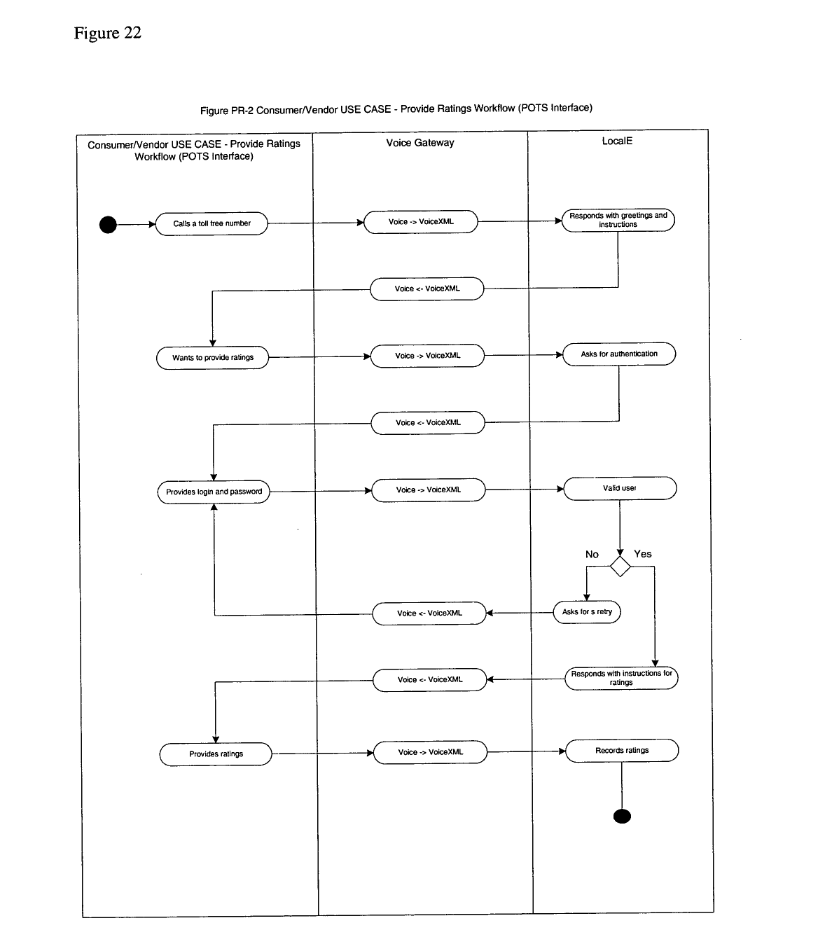

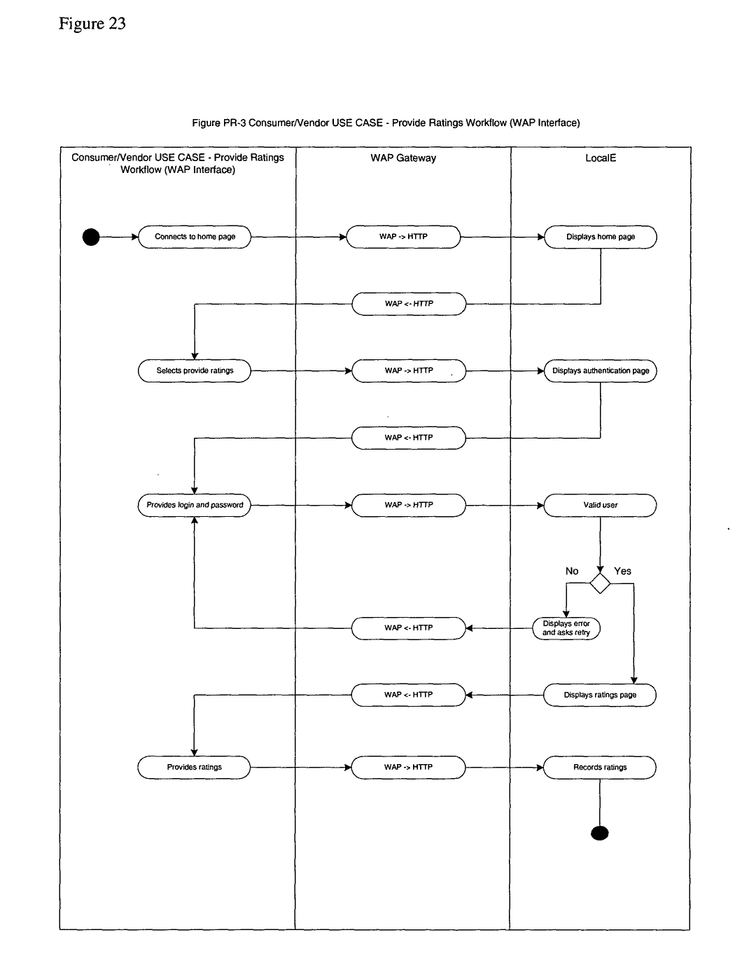

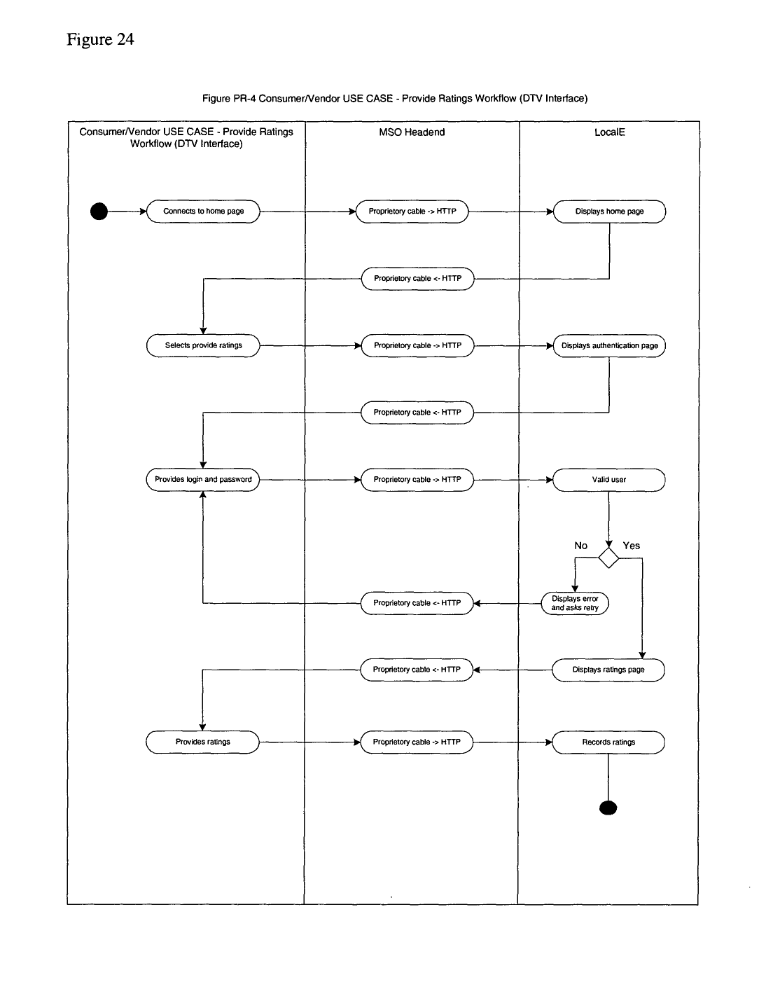

This use case also has four scenarios:
Web Interface PR-1 (FIG. 21)
POTS Interface PR-2 (FIG. 22)
WAP Interface PR-3 (FIG. 23)
DTV Interface PR-4 (FIG. 24)
   The workflows are self-explanatory and will not be further described.

From the above description, it should be readily apparent that numerous other modifications and combinations of the above disclosure may be made without departing form the scope of the present invention. For example, while the invention is implemented using Web Services, those skilled in the art will appreciate that such an approach is not necessary. Further, the processes described herein are intended as specific implementations only and are not intended to delimit the scope of the invention, which should instead be understood with reference to the following claims.

1. A computer-implemented method for matching consumers and service providers for the provision of services by the service providers to the consumers, comprising the steps of:
receiving from a plurality of service providers registration data based on type of service provided by each service provider and storing the registration data in a Web Services registry and a system database as service provider profiles;
receiving from a consumer a request for service including parameters identifying characteristics of the service requested;
filtering the request for service through the service provider profiles stored in the system database for service provider profiles having characteristics matching the characteristics specified by the consumer and presenting service provider information for the service providers resulting from the filtering to the consumer for selection;
receiving a service provider selection from the consumer and an indication of how the consumer would like to be contacted by the selected service provider;
contacting the selected service provider with the consumer's request for service in a manner specified by the service provider in the service provider's registration data;
receiving a response from the selected service provider indicating whether the service provider will accept the consumer's request; and
if the selected service provider accepts the consumer's request for service, then charging the service provider a fee and providing contact information for the consumer to the selected service provider upon receipt of payment of the fee.

2. A method as in claim 1, wherein the service provider registration data is stored in the Web Services registry and the system database as XML (XPath) profiles.

3. A method as in claim 1, wherein the step of contacting the selected service provider includes the step of converting the consumer's request for service to a voice signal if the selected service provider has indicated in its registration data that it would like to be contacted by phone.

4. A method as in claim 1, wherein the step of contacting the selected service provider includes the step of transmitting the consumer's request for service to the selected service provider as text over at least one of a) an Internet data connection and b) a cable television headend.

5. A method as in claim 1, wherein the step of contacting the selected service provider comprises the step of simultaneously contacting each service provider identified in the filtering step in a broadcast including the consumer's request for service.

6. A method as in claim 1, wherein the step of contacting the selected service provider comprises the step of sequentially contacting respective service providers identified in the filtering step in an order specified by the consumer.

7. A method as in claim 1, comprising the further step of enabling the consumer to follow the status of the consumer's request for service, including whether the consumer's request for service has been accepted by the selected service provider.

8. A method as in claim 1, comprising the further step of enabling the selected service provider to follow the status of an accepted consumer's request for service, including whether the consumer's request for service has been provided to another service provider.

9. A method as in claim 1, comprising the further step of providing an interface through which the consumer may rate service providers.

10. A method as in claim 1, wherein the system database and the Web Services registry list service providers in a geographic region in proximity to the location specified by the consumer.

11. A computer configured to match consumers and service providers for the provision of services by the service providers to the consumers, comprising:
a web server connected via at least one gateway to the Internet and configured to receive data from a plurality of service providers via at least one of a plurality of communications devices, the data from the service providers including registration data based on type of service provided by each service provider, and a consumer request for a service from a consumer via at least one of a plurality of communications devices, the consumer request for service including parameters identifying characteristics of the service requested;
a Web Services registry that stores a subset of the registration data for service providers;
a database that replicates what is stored in the Web Services registry for record keeping purposes and maintains comprehensive registration and transactional data for the service providers and the consumers, the requests for services, and responses along with the service provider profiles; and
an application server programmed to filter the requests for services through the service provider profiles having characteristics matching the characteristics specified by the consumer and presenting service provider information for the service providers resulting from the filtering to the consumer for selection, to receive a service provider selection from the consumer and an indication of how the consumer would like to be contacted by the selected service provider, to contact the selected service provider with the consumer's request for service in a manner specified by the service provider in the service provider's registration data, to receive a response from the selected service provider indicating whether the service provider will accept the consumer's request, and if the selected service provider accepts the consumer's request for service, then to charge the service provider a fee and to provide contact information for the consumer to the selected service provider upon receipt of payment of the fee.

12. A computer as in claim 11, wherein the service provider registration data is stored in the Web Services registry and the system database as XML (XPath) profiles.

13. A computer as in claim 11, wherein the at least one gateway converts the consumer's request for service to a voice signal if the selected service provider has indicated in its registration data that it would like to be contacted by phone.

14. A computer as in claim 11, wherein the at least one gateway transmits the consumer's request for service to the selected service provider as text over at least one of a) an Internet data connection and b) a cable television headend.

15. A computer as in claim 11, wherein the application server broadcasts the consumer's request for service simultaneously to each service provider identified in the filtering step.

16. A computer as in claim 11, wherein the application server sequentially contacts respective service providers identified in the filtering step in an order specified by the consumer.

17. A computer as in claim 11, wherein the application server is further programmed to enable the consumer to follow the status of the consumer's request for service, including whether the consumer's request for service has been accepted by the selected service provider.

18. A computer as in claim 11, wherein the application server is further programmed to enable the selected service provider to follow the status of an accepted consumer's request for service, including whether the consumer's request for service has been provided to another service provider.

19. A computer as in claim 11, wherein the application server further provides an interface through which the consumer may rate service providers.

20. A computer as in claim 11, wherein the Web Services registry and the system database store a list of service providers in a geographic region in proximity to the consumer.

21. A computer as in claim 11, wherein the application server is further programmed to determine a type of client used by the consumer or a service provider to contact the web server and to adapt communications from the web server to the client in accordance with the type of client detected.
